(19) United States
(12) Patent Application Publication
(10) Pub. No.: US 2010/0194704 A1
(43) Pub. Date: Aug. 5, 2010

(54) DISPLAY DEVICE, TOUCH SENSOR, AND METHOD FOR MANUFACTURING DISPLAY DEVICE

(75) Inventors: Takeo Koito, Aichi (JP); Masaya Tamaki, Kanagawa (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/694,350

(22) Filed: Jan. 27, 2010

(30) Foreign Application Priority Data
Feb. 4, 2009 (JP) 2009-023920

(51) Int. Cl. G06F 3/041

(52) U.S. Cl. 345/173

(57) ABSTRACT

Disclosed herein is a display device including: a display panel configured to display an image in a display area and have a substrate over which a protruding elastic member and an electrode provided on the elastic member are formed in the display area; wherein a plurality of steps are provided in the elastic member in a direction perpendicular to a surface of the substrate, and the electrode is so provided on the elastic member as to include part covering a surface of the plurality of steps.

### BACKGROUND OF THE INVENTION

1. Field of the Invention

The present invention relates to display devices, touch sensors, and methods for manufacturing a display device, and particularly to a display device, a touch sensor, and a method for manufacturing a display device in each of which a protruding elastic member is formed and an electrode is formed on this elastic member.

2. Description of the Related Art

Display devices such as liquid crystal display devices and organic EL display devices have advantages such as small thickness, light weight, and low power consumption.

As one of such display devices, the liquid crystal display device has a liquid crystal panel obtained by enclosing a liquid crystal layer between a pair of substrates as a display panel. The liquid crystal panel is e.g. a transmissive panel. Specifically, illuminating light emitted from an illuminating device such as a backlight provided on the back side of the liquid crystal panel is modulated by the liquid crystal panel and passes through the liquid crystal panel. By the modulated illuminating light, image displaying is carried out on the front side of the liquid crystal panel.

This liquid crystal panel is based on e.g. the active-matrix system and includes a TFT array substrate over which plural thin film transistors (TFTs) functioning as pixel switching elements are formed. Furthermore, in this liquid crystal panel, a counter substrate is so disposed as to be opposed to this TFT array substrate and the liquid crystal layer is provided between the TFT array substrate and the counter substrate. In this liquid crystal panel of the active-matrix system, the pixel switching element inputs potential to a pixel electrode to thereby apply voltage to the liquid crystal layer and control the transmittance of the light passing through the pixel. Thus, the image displaying is carried out.

For the above-described display device, a touch panel is often provided on the display panel in order to allow the user to input operation data by utilizing images such as icons displayed on the screen of the display panel.

However, if the touch panel is provided as an external component on the display panel, the total panel thickness is increased and the advantage of small thickness is possibly spoiled. Furthermore, possibly the touch panel decreases the light passing through the display area and interferes with the light, so that the quality of displayed images is possibly lowered. Moreover, troubles such as the lowering of the manufacturing efficiency and increase in the manufacturing cost are possibly caused.

To address these problems, display devices with a display panel having a built-in touch panel function have been proposed.

For example, there have been proposed liquid crystal display devices with a liquid crystal panel having built-in touch sensors of e.g. the “contact type,” in which readout is carried out based on voltage change responding to contact between electrodes.

In the liquid crystal display devices, a touch electrode is provided on each of a pair of substrates of the liquid crystal panel. The pair of touch electrodes are electrically connected to each other when the liquid crystal panel is pushed and deformed. In this liquid crystal panel, the touch electrode is provided on a protruding elastic member so that the pair of touch electrodes can be electrically connected to each other even by low external pressure (refer to e.g. Japanese Patent Laid-Open No. 2001-75074, Japanese Patent Laid-Open No. 2007-52368, and Japanese Patent Laid-Open No. 2007-95044).

### SUMMARY OF THE INVENTION

In the above-described display device, reduction in the thickness of the display panel increases the possibility of the breaking of a component such as the electrode due to external pressure, and possibly lowers the device reliability.

The occurrence of this trouble possibly emerges particularly if the touch electrode composed of a rigid material is provided on the protruding elastic member in the liquid crystal panel having the built-in touch sensors. For example, possibly the breaking of the touch electrode occurs and the touch panel function is spoiled.

FIGS. 31A to 31C are sectional views showing a major part of a liquid crystal panel 200J having built-in touch sensors.

As shown in FIG. 31A, on a TFT array substrate 201J, a first touch electrode 212J is provided on a protruding elastic member 211J. On the other hand, a second touch electrode 222J is provided on a counter substrate 202J.

In this case, as shown in FIG. 31B, the second touch electrode 222J is brought into contact with the first touch electrode 212J if the counter substrate 202J is pushed toward the TFT array substrate 201J and deformed. At this time, as shown in FIG. 31B, the inflecting part over the area from the upper surface part to the side surface part of the projecting elastic member 211J is deformed to a large extent. Thus, part of the first touch electrode 212 J formed on this inflecting part of the elastic member 211J is possibly broken due to the deformation.

Consequently, as shown in FIG. 31C, possibly the breaking of the first touch electrode 212J occurs and the above-described trouble is caused.

It may be effective to increase the area of the surface of the protruding elastic member on which the touch electrode is provided in order to avoid the trouble. However, in this case, the aperture ratio of the liquid crystal panel is lowered and thus the quality of displayed images is possibly lowered.

In addition, possibly the breaking of not only the touch electrode but also the pixel electrode occurs and a similar trouble is caused. For example, the occurrence of this trouble possibly emerges if the pixel electrode is formed on a protruding elastic member in a semi-transmissive liquid crystal panel.

As above, in the display device, troubles such as the lowering of the image quality due to a decrease in the aperture ratio and the lowering of the device reliability possibly occur.

There is a need to provide a display device, a touch sensor, and a method for manufacturing a display device, each capable of realizing enhancement in the image quality and enhancement in the device reliability.

According to an embodiment of the present invention, there is provided a display device including a display panel configured to display an image in a display area and have a substrate over which a protruding elastic member and an electrode provided on the elastic member are formed in the display area. A plurality of steps are provided in the elastic member in the direction perpendicular to a surface of the substrate. The electrode is so provided on the elastic member as to include part covering a surface of the plurality of steps.

According to another embodiment of the present invention, there is provided a display device including a display panel configured to include a touch sensor provided in a display area for displaying an image and have a substrate and a counter substrate opposed to the substrate with the intermediary of a space. The touch sensor has a first touch electrode provided over a surface of the substrate opposed to the counter substrate, and a second touch electrode provided over a surface of the counter substrate opposed to the substrate in such a manner as to face the first touch electrode with the intermediary of a space. The touch sensor is so configured that the display panel is deformed due to external pressure and the first touch electrode and the second touch electrode get contact with each other. The substrate includes an elastic member protruding in the direction toward the counter substrate over the surface of the substrate opposed to the counter substrate. A plurality of steps are provided in the elastic member in the direction toward the counter substrate. The first touch electrode is provided on a surface of the elastic member opposed to the counter substrate in such a manner as to include part covering a surface of the plurality of steps of the elastic member.

According to another embodiment of the present invention, there is provided a touch sensor including a substrate and a counter substrate configured to be so disposed as to be opposed to the substrate. The substrate includes an elastic member protruding in the direction toward the counter substrate over a surface of the substrate opposed to the counter substrate, and a first touch electrode provided on a surface of the elastic member opposed to the counter substrate. The counter substrate includes a second touch electrode provided over a surface of the counter substrate opposed to the substrate in such a manner as to face the first touch electrode with the intermediary of a space. At least one of the substrate and the counter substrate is deformed due to external pressure and the first touch electrode and the second touch electrode get contact with each other. A plurality of steps are provided in the elastic member in the direction toward the counter substrate. The first touch electrode is so provided on the elastic member as to include part covering a surface of the plurality of steps of the elastic member.

According to another embodiment of the present invention, there is provided a method for manufacturing a display device. The method includes the step of manufacturing a display panel for displaying an image in a display area. The step of manufacturing the display panel includes the sub-steps of forming a protruding elastic member over a substrate, and forming an electrode on the elastic member. In the sub-step of forming the elastic member, the elastic member is so formed that a plurality of steps are provided in the direction perpendicular to a surface of the substrate. In the sub-step of forming the electrode, the electrode is so provided on the elastic member as to cover a surface of the plurality of steps of the elastic member.

In the embodiments of the present invention, the protruding elastic member is formed over the substrate. This elastic member is so formed that the plurality of steps are provided in the direction perpendicular to the surface of the substrate. Specifically, the elastic member is so formed as to include a first step formed with a first height as the largest height and a second step formed with a second height lower than the first height. Furthermore, the electrode is formed on the elastic member. This electrode is so provided on the elastic member as to cover the surface of the plurality of steps of the elastic member. Specifically, the electrode is so provided on the elastic member as to include the part covering the surface of the first step and the second step of the elastic member. Therefore, large deformation of the elastic member in response to application of external pressure from the upper side of the electrode can be prevented. Thus, the breaking of the electrode can be prevented.

The embodiments of the present invention can provide a display device, a touch sensor, and a method for manufacturing a display device, each capable of realizing enhancement in the image quality and enhancement in the device reliability.

### BRIEF DESCRIPTION OF THE DRAWINGS

FIG. 1 is a sectional view showing the configuration of a liquid crystal display device according to a first embodiment of the present invention;

FIG. 2 is a plan view showing a liquid crystal panel according to the first embodiment of the present invention;

FIG. 3 is a diagram showing a major part of the liquid crystal panel according to the first embodiment of the present invention;

FIG. 4 is a diagram showing a major part of the liquid crystal panel according to the first embodiment of the present invention;

FIGS. 5A and 5B are diagrams showing a major part of the liquid crystal panel according to the first embodiment of the present invention;

FIG. 6 is a diagram showing a major part of the liquid crystal panel according to the first embodiment of the present invention;

FIGS. 7A to 7E are waveform diagrams of control signals supplied to the respective components by a controller when the liquid crystal display device according to the first embodiment of the present invention is operated;

FIG. 8 is a sectional view showing the appearance when a sensing target gets contact with a display area of the liquid crystal panel in the liquid crystal display device according to the first embodiment of the present invention;

FIGS. 9A and 9B are sectional views showing steps for forming an elastic member in the first embodiment of the present invention;

FIGS. 10A and 10B are diagrams showing an elastic member in an enlarged manner in a liquid crystal display device according to a second embodiment of the present invention;

FIGS. 11A to 11C are sectional views showing steps for forming the elastic member in the second embodiment of the present invention;

FIGS. 12A and 12B are diagrams showing the amount of deformation in the step part of the elastic member 63b in the second embodiment of the present invention;

FIGS. 13A and 13B are diagrams showing an elastic member in an enlarged manner in a liquid crystal display device according to a third embodiment of the present invention;

FIGS. 14A to 14C are sectional views showing steps for forming the elastic member in the third embodiment of the present invention;

FIGS. 15A and 15B are diagrams showing an elastic member in an enlarged manner in a liquid crystal display device according to a fourth embodiment of the present invention;

FIGS. 16A and 16B are sectional views showing steps for forming the elastic member in the fourth embodiment of the present invention;

FIGS. 17A and 17B are diagrams showing an elastic member in an enlarged manner in a liquid crystal display device according to a fifth embodiment of the present invention;

FIGS. 18A and 18B are diagrams showing an elastic member in an enlarged manner in a liquid crystal display device according to a modification example of the fifth embodiment of the present invention;

FIGS. 19A and 19B are sectional views showing steps for forming an elastic member in a sixth embodiment of the present invention;

FIGS. 20A to 20G are diagrams showing elastic members in an enlarged manner in a liquid crystal display device according to an embodiment of the present invention;

FIGS. 21A to 21D are sectional views showing steps for forming an elastic member and spacers in an embodiment of the present invention;

FIG. 22 is a sectional view schematically showing the rough configuration of a pixel provided in a display area in a liquid crystal panel according to an embodiment of the present invention;

FIG. 23 is a top view of an elastic member in the liquid crystal panel according to the embodiment of the present invention;

FIG. 24 is a sectional view schematically showing the rough configuration of a pixel provided in a display area in a liquid crystal panel according to an embodiment of the present invention;

FIGS. 25A to 25C are sectional views showing elastic members in embodiments of the present invention;

FIG. 26 is a diagram showing an electronic apparatus to which the liquid crystal display device according to any of the embodiments of the present invention is applied;

FIG. 27 is a diagram showing an electronic apparatus to which the liquid crystal display device according to any of the embodiments of the present invention is applied;

FIG. 28 is a diagram showing an electronic apparatus to which the liquid crystal display device according to any of the embodiments of the present invention is applied;

FIG. 29 is a diagram showing an electronic apparatus to which the liquid crystal display device according to any of the embodiments of the present invention is applied;

FIG. 30 is a diagram showing an electronic apparatus to which the liquid crystal display device according to any of the embodiments of the present invention is applied; and

FIGS. 31A to 31C are sectional views showing a major part of a liquid crystal panel having built-in touch sensors.

### DETAILED DESCRIPTION OF THE PREFERRED EMBODIMENTS

Embodiments of the present invention will be described below.

The description will be made in the following order.

1. First Embodiment (the position of the lower step of the elastic member is at an end in top view)
2. Second Embodiment (the position of the lower step of the elastic member is at the center in top view)
3. Third Embodiment (the planar shape of the lower step of the elastic member is a triangle)
4. Fourth Embodiment (the elastic member has three steps)
5. Fifth Embodiment (the plural steps of the elastic member are provided around a contact)
6. Sixth Embodiment (the plural steps of the elastic member are provided by stacking plural components)

### 7. Modification Examples

### 1. First Embodiment

### The Position of the Lower Step of the Elastic Member is at an End in Top View

### (Configuration of Liquid Crystal Display Device)

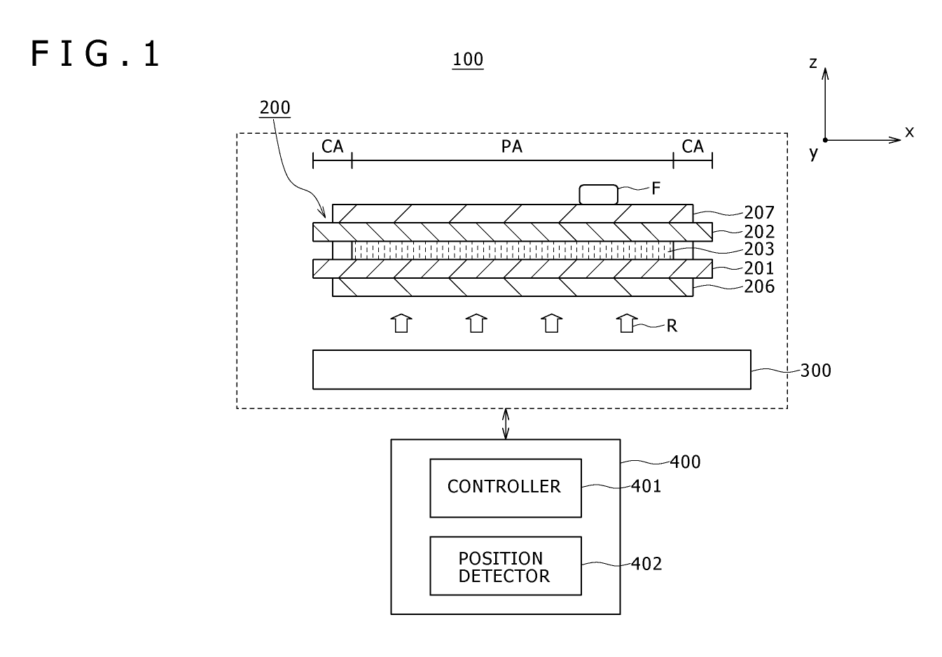

FIG. 1 is a sectional view showing the configuration of a liquid crystal display device 100 according to a first embodiment of the present invention.

As shown in FIG. 1, the liquid crystal display device 100 of the present embodiment has a liquid crystal panel 200, a backlight 300, and a data processor 400. These respective units will be sequentially described below.

The liquid crystal panel 200 is based on the active-matrix system and has a TFT array substrate 201, a counter substrate 202, and a liquid crystal layer 203 as shown in FIG. 1. In the liquid crystal panel 200, the TFT array substrate 201 and the counter substrate 202 are opposed to each other with the intermediary of a space therebetween. The liquid crystal layer 203 is so provided as to be sandwiched between the TFT array substrate 201 and the counter substrate 202.

In the liquid crystal panel 200, as shown in FIG. 1, a first polarizer 206 is disposed on the surface of the TFT array substrate 201 on the opposite side to the surface thereof opposed to the counter substrate 202. Furthermore, a second polarizer 207 is disposed on the surface of the counter substrate 202 on the opposite side to the surface thereof opposed to the TFT array substrate 201.

For this liquid crystal panel 200, the backlight 300 is disposed on the side of the TFT array substrate 201. The surface of the TFT array substrate 201 on the opposite side to the surface thereof opposed to the counter substrate 202 is irradiated with illuminating light R emitted from the backlight 300.

This liquid crystal panel 200 includes a display area PA in which plural pixels (not shown) are disposed. In this display area PA, the illuminating light R emitted from the backlight 300 provided on the back surface side of the liquid crystal panel 200 is received by the back surface via the first polarizer 206. The illuminating light R received by the back surface is modulated in the display area PA.

Plural TFTs are so provided as pixel switching elements (not shown) over the TFT array substrate 201 as to correspond to the pixels. Through control of the pixel switching elements, the illuminating light received by the back surface is modulated. The modulated illuminating light R is output to the front surface side via the second polarizer 207, so that an image is displayed in the display area PA. For example, a color image is displayed on the front surface side of the liquid crystal panel 200. That is, the liquid crystal panel 200 is a transmissive panel.

Furthermore, in the present embodiment, this liquid crystal panel 200 includes touch sensors (not shown) of the “contact type,” in which readout is carried out based on voltage change responding to contact between electrodes, details of which will be described later. The touch sensor is so configured as to output a signal of different potential depending on the position at which a sensing target F such as a finger of the user gets contact with the front surface of the liquid crystal panel 200 on the opposite side to the back surface side, on which the backlight 300 is provided.

The backlight 300 faces the back surface of the liquid crystal panel 200 and outputs the illuminating light R to the display area PA of the liquid crystal panel 200 as shown in FIG. 1.

Specifically, the backlight 300 is located on the side of the TFT array substrate 201, and emits the illuminating light R to the surface of the TFT array substrate 201 on the opposite side to the surface thereof opposed to the counter substrate 202. That is, the backlight 300 emits the illuminating light R in such a way that the illuminating light R is directed from the side of the TFT array substrate 201 toward the side of the counter substrate 202. In this embodiment, the backlight 300 emits the illuminating light R along the normal direction z of the surface of the liquid crystal panel 200.

The data processor 400 has a controller 401 and a position detector 402 as shown in FIG. 1. The data processor 400 includes a computer and is so configured that the computer operates as these respective units based on a program.

The controller 401 in the data processor 400 controls the operation of the liquid crystal panel 200 and the backlight 300. The controller 401 supplies a control signal to the liquid crystal panel 200 to thereby control the operation of the plural pixel switching elements (not shown) provided in the liquid crystal panel 200. For example, the controller 401 makes the liquid crystal panel 200 carry out line-sequential driving. Furthermore, the controller 401 supplies a control signal to the backlight 300 to thereby control the operation of the backlight 300 and make the backlight 300 emit the illuminating light R. In this manner, the controller 401 controls the operation of the liquid crystal panel 200 and the backlight 300 to thereby display an image in the display area PA of the liquid crystal panel 200.

In addition, the controller 401 supplies a control signal to the liquid crystal panel 200 to thereby control the operation of the touch sensors provided in the liquid crystal panel 200 and collect data from the touch sensors.

The position detector 402 in the data processor 400 detects the position of the sensing target F, such as a finger of a human body, brought into contact with the display area PA on the front surface side of the liquid crystal panel 200. In the present embodiment, the position detector 402 carries out the position detection based on data obtained from touch sensor elements (not shown) provided in the liquid crystal panel 200.

### (Entire Configuration of Liquid Crystal Panel)

The entire configuration of the liquid crystal panel 200 will be described below.

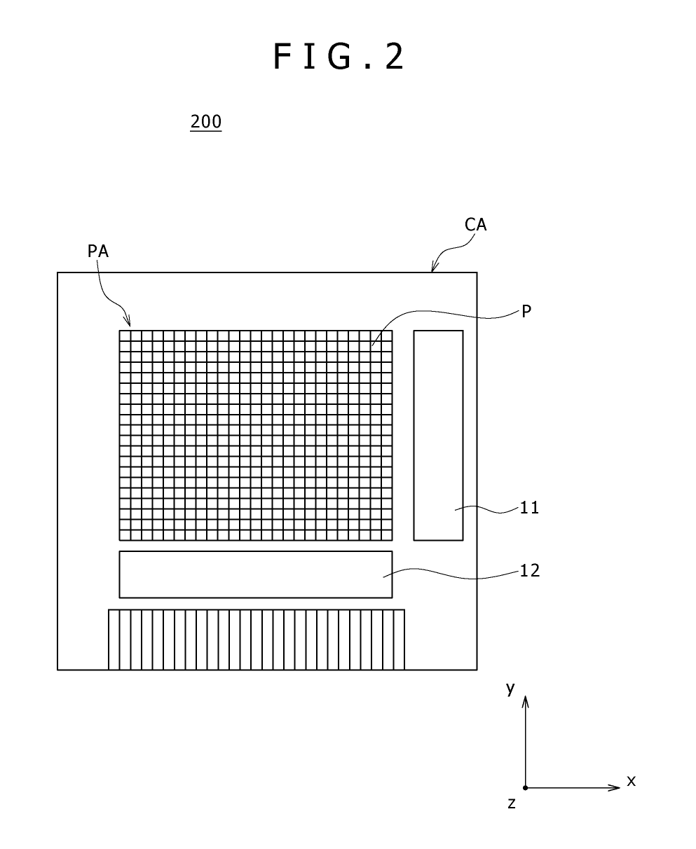

FIG. 2 is a plan view showing the liquid crystal panel 200 according to the first embodiment of the present invention.

As shown in FIG. 2, the liquid crystal panel 200 has the display area PA and a peripheral area CA.

In the liquid crystal panel 200, plural pixels P are disposed in the display area PA along the surface as shown in FIG. 2. Specifically, in the display area PA, the plural pixels P are arranged in a matrix along each of the horizontal direction x and the vertical direction y, for displaying an image. The pixels P each include the pixel switching element (not shown), details of which will be described later. Furthermore, the plural touch sensors (not shown) are so provided as to correspond to the plural pixels P.

In the liquid crystal panel 200, the peripheral area CA is so located as to surround the display area PA as shown in FIG. 2. In this peripheral area CA, a vertical drive circuit 11 and a horizontal drive circuit 12 are formed as shown in FIG. 2. These respective circuits are formed by using e.g. semiconductor elements formed similarly to the above-described pixel switching elements (not shown).

The vertical drive circuit 11 and the horizontal drive circuit 12 drive the pixel switching elements provided corresponding to the pixels P to thereby carry out image displaying in the display area PA.

In addition, the vertical drive circuit 11 and the horizontal drive circuit 12 drive the touch sensors (not shown) provided in the display area PA to thereby acquire data from the touch sensors. Based on the data acquired from the touch sensors, the position detector 402 detects the position at which a sensing target such as a finger of the user gets contact with the display area PA of the liquid crystal panel 200.

### (Detailed Configuration of Liquid Crystal Panel)

The detailed configuration of the liquid crystal panel 200 will be described below.

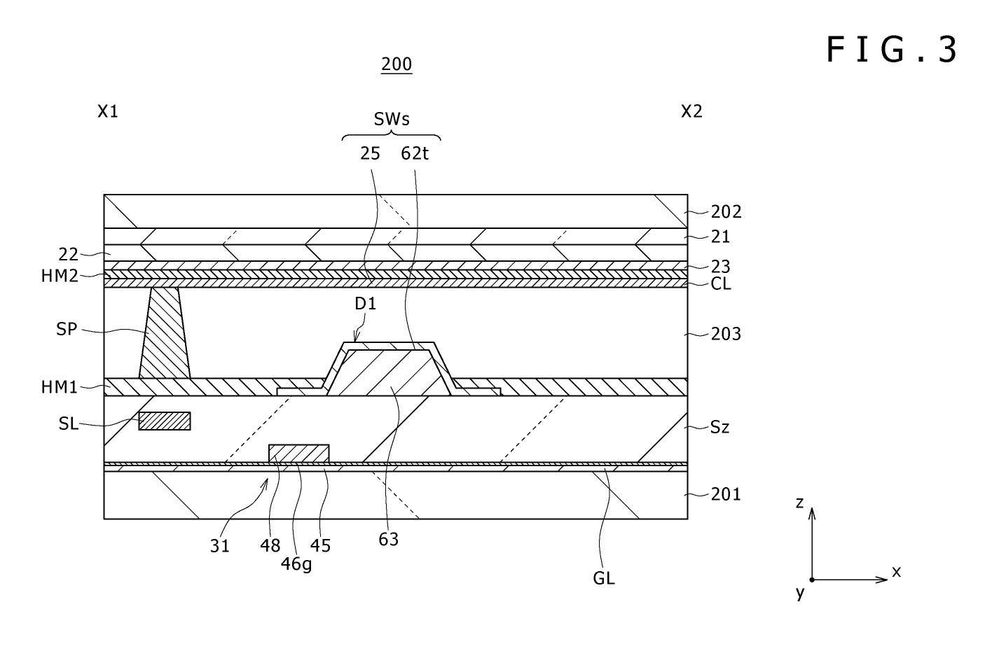

FIGS. 3 to 6 are diagrams showing a major part of the liquid crystal panel 200 according to the first embodiment of the present invention.

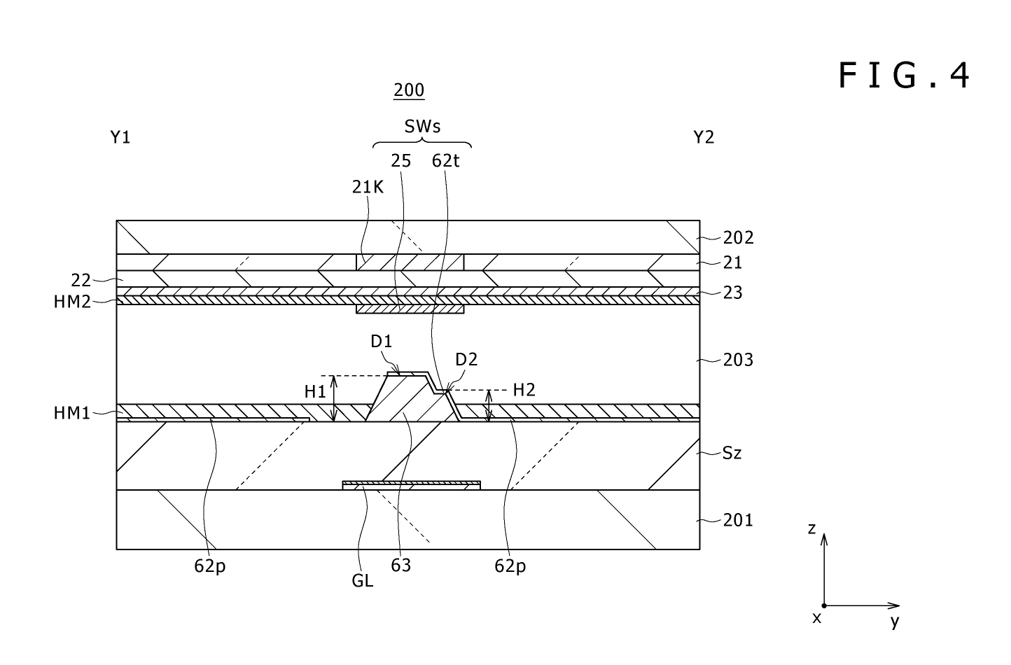

FIGS. 3 and 4 are sectional views schematically showing the rough configuration of the pixel P provided in the display area PA in the liquid crystal panel 200 according to the first embodiment of the present invention.

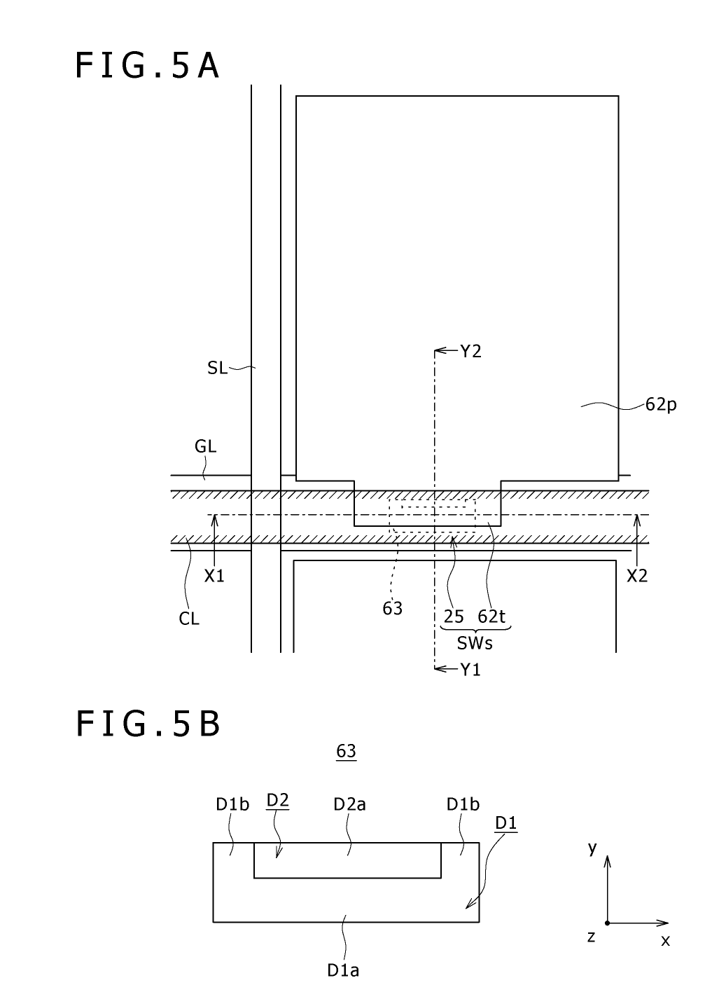

FIGS. 5A and 5B are top views schematically showing the rough configuration of the pixel P provided in the display area PA in the liquid crystal panel 200 according to the first embodiment of the present invention. FIG. 5A shows the whole of the pixel P, and FIG. 5B shows an elastic member 63 provided in the pixel P as an enlarged view. FIG. 3 shows the section along line X1-X2 in FIG. 5A, and FIG. 4 shows the section along line Y1-Y2 in FIG. 5A.

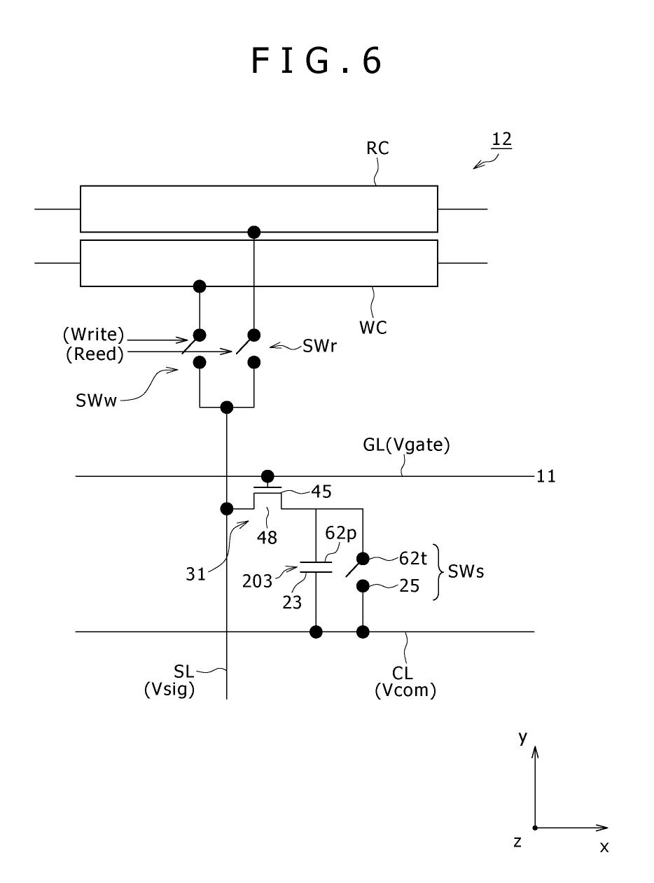

FIG. 6 is a circuit diagram showing the schematic configuration of the pixel P provided in the display area PA in the liquid crystal panel 200 according to the first embodiment of the present invention.

The pixel P is so formed that sub-pixels of three primary colors of red, green, and blue are combined into one set. The following description relates to a major part of one sub-pixel.

In the liquid crystal panel 200, as shown in FIGS. 3 and 4, a spacer SP is interposed between the TFT array substrate 201 and the counter substrate 202 and these substrates are bonded to each other by a sealing material (not shown). The liquid crystal layer 203 is enclosed between the TFT array substrate 201 and the counter substrate 202.

In the present embodiment, as shown in FIGS. 3, 4, 5A and 5B, the liquid crystal panel 200 has built-in touch sensors SWs. This touch sensor SWs is composed of a pair of touch electrodes 62t and 25 as shown in FIGS. 3, 4, 5A and 5B.

The respective components of the liquid crystal panel 200 will be described below.

Details of the TFT array substrate 201 will be described below.

The TFT array substrate 201 is a substrate composed of an optically-transparent insulator, and is formed of e.g. glass. As shown in FIGS. 3 and 4, over the surface of the TFT array substrate 201 opposed to the counter substrate 202, a pixel switching element 31, a pixel electrode 62p, and the touch electrode 62t as one of the electrodes of the touch sensor SWs are formed.

The respective components provided over the TFT array substrate 201 will be described below.

As shown in FIG. 3, the pixel switching element 31 is provided on the surface of the TFT array substrate 201 opposed to the counter substrate 202. The pixel switching element 31 includes a gate electrode 45, a gate insulating film 46g, and a semiconductor layer 48, and is formed as e.g. a bottom-gate TFT.

In the pixel switching element 31, the gate electrode 45 is formed on the TFT array substrate 201 as shown in FIGS. 3 and 4. Furthermore, as shown in FIG. 6, the gate electrode 45 is electrically connected to a gate line GL.

As shown in FIGS. 3, 4, and 5, the gate line GL extends along the x direction, and the gate electrode 45 is formed monolithically with this gate line GL. For example, the gate electrode 45 and the gate line GL are formed by using a metal material such as molybdenum.

Furthermore, as shown in FIG. 6, the gate line GL is electrically connected to the vertical drive circuit 11. To the gate electrode 45, a scan signal Vgate is supplied from the vertical drive circuit 11 via the gate line GL.

In the pixel switching element 31, the gate insulating film 46g is provided on the gate electrode 45 as shown in FIGS. 3 and 4. This gate insulating film 46g is formed by using an insulating material such as a silicon oxide film.

In the pixel switching element 31, the semiconductor layer 48 is so formed as to include the part opposed to the gate electrode 45 with the intermediary of the gate insulating film 46g as shown in FIGS. 3 and 4. For example, the semiconductor layer 48 is formed by using a semiconductor material such as poly-silicon. In this semiconductor layer 48, a pair of source/drain regions (not shown) are so formed as to sandwich a channel forming region (not shown) opposed to the gate electrode 45 with the intermediary of the gate insulating film 46g.

As shown in FIG. 6, one of the source/drain regions (not shown) in the semiconductor layer 48 is electrically connected to a signal line SL.

As shown in FIG. 3, the signal line SL is provided in an interlayer insulating film Sz, which is so formed over the TFT array substrate 201 as to cover the pixel switching element 31. This signal line SL is so formed as to extend along the y direction as shown in FIG. 5A. The above-described one of the source/drain regions (not shown) is electrically connected to the signal line SL via an electrically-conductive layer (not shown) provided in the interlayer insulating film Sz.

As shown in FIG. 6, the end of the signal line SL on the opposite side to the end thereof connected to the pixel switching element 31 is electrically connected to the horizontal drive circuit 12. In the present embodiment, the horizontal drive circuit 12 includes a write circuit WC and a readout circuit RC. A switch SWw is interposed between the signal line SL and the write circuit WC, and the signal line SL is electrically connected to the write circuit WC when the switch SWw is in the on-state. Furthermore, a switch SWr is interposed between the signal line SL and the readout circuit RC, and the signal line SL is electrically connected to the readout circuit RC when the switch SWr is in the on-state. These two switches SWw and SWr are differentially operated and the operation thereof is so controlled that they are prevented from being in the on-state simultaneously, details of which will be described later. Therefore, when the switch SWw is set to the on-state, the signal line SL is electrically connected to the write circuit WC and is supplied with a write signal (Write) from the write circuit WC. When the switch SWr is set to the on-state, the signal line SL is electrically connected to the readout circuit RC and is supplied with a read signal (Read) from the readout circuit RC.

On the other hand, the other of the source/drain regions (not shown) in the semiconductor layer 48 is electrically connected to the pixel electrode 62p as shown in FIG. 6. In addition, the other of the source/drain regions (not shown) in the semiconductor layer 48 is electrically connected to the touch electrode 62t as one of the pair of touch electrodes 25 and 62t of the touch sensor SWs as shown in FIG. 6.

As shown in FIG. 4, the pixel electrode 62p and the touch electrode 62t are formed monolithically with each other on the interlayer insulating film Sz on the TFT array substrate 201, details of which will be described later. Therefore, the other of the source/drain regions (not shown) is electrically connected to each of the pixel electrode 62p and the touch electrode 62t via a contact (not shown) provided in the interlayer insulating film Sz.

As shown in FIGS. 3 and 4, each of the pixel electrode 62p and the touch electrode 62t is formed over the surface of the TFT array substrate 201 opposed to the counter substrate 202 with the intermediary of the interlayer insulating film Sz. Each of the pixel electrode 62p and the touch electrode 62t is a so-called transparent electrode and is formed by using e.g. ITO. The pixel electrode 62p and the touch electrode 62t are so formed as to be monolithic with each other and are electrically connected to each other.

As shown in FIG. 5A, the pixel electrode 62p is formed with a rectangular pattern corresponding to the area defined by the gate line GL and the signal line SL in the xy plane.

As shown in FIG. 6, the pixel electrode 62p is electrically connected to one terminal of the pixel switching element 31 and gives potential to the liquid crystal layer 203.

On the other hand, as shown in FIG. 5A, the touch electrode 62t also has a rectangular shape in the xy plane but the width thereof in the x direction is smaller than that of the pixel electrode 62p. Furthermore, this touch electrode 62t is so provided as to cover the surface of the elastic member 63 as shown in FIGS. 3 and 4.

As shown in FIGS. 3 and 4, the elastic member 63 is provided above the gate line GL with the intermediary of the interlayer insulating film Sz. For example, the elastic member 63 is formed by using an acrylic resin. The elastic member 63 is provided on the interlayer insulating film Sz in such a manner as to protrude toward the counter substrate 202. As shown in FIG. 3, the elastic member 63 is so formed that its height is lower than that of the spacer SP for keeping the cell gap.

In the present embodiment, as shown in FIG. 4, plural steps are provided in the elastic member 63 in the z direction perpendicular to the xy plane of the TFT array substrate 201.

Specifically, as shown in FIG. 4, the elastic member 63 includes a first step D1 formed with a first height H1 and a second step D2 formed with a second height H2 lower than the first height H1 on the xy plane of the TFT array substrate 201.

As shown in FIG. 5B, the first step D1 of the elastic member 63 includes, in the xy plane, a surface D1a extending along the x direction and surfaces D1b extending toward the upper side from both ends of the surface extending along the x direction. That is, the first step D1 is so formed that its planar shape in the xy plane is a U-character shape. The second step D2 of the elastic member 63 includes a rectangular surface D2a extending along the x direction in the xy plane, and this surface D2a is surrounded by the respective surfaces D1a and D1b of the first step D1.

In this elastic member 63, the area of the higher first step D1 is larger than that of the lower second step D2 as shown in FIG. 5B.

As shown in FIG. 4, the touch electrode 62t is formed on the elastic member 63 in such a manner as to include the part covering the surface of the plural steps provided in the elastic member 63. Specifically, the touch electrode 62t is so provided on the elastic member 63 as to include the part covering the surface of the first step D1 and the second step D2, and is formed monolithically with the pixel electrode 62p. In the present embodiment, the touch electrode 62t is so formed as not to cover the side surface of the elastic member 63 on the opposite side to the side surface thereof on which the pixel electrode 62p is provided as shown in FIG. 4.

This touch electrode 62t is so configured as to function as one terminal of the touch sensor SWs as a switch as shown in FIG. 6.

In addition, as shown in FIGS. 3 and 4, a liquid crystal alignment film HM1 is provided on the pixel electrode 62p over the TFT array substrate 201.

In the present embodiment, this liquid crystal alignment film HM1 is so formed that the surface of the touch electrode 62t is exposed. For example, this liquid crystal alignment film HM1 is formed by using polyimide.

Details of the counter substrate 202 will be described below.

The counter substrate 202 is a substrate composed of an optically-transparent insulator similarly to the TFT array substrate 201, and is formed of e.g. glass. As shown in FIGS. 3 and 4, this counter substrate 202 is opposed to the TFT array substrate 201 with the intermediary of a space therebetween. Over the surface of the counter substrate 202 opposed to the TFT array substrate 201, a color filter layer 21, a counter electrode 23, and the touch electrode 25 are formed as shown in FIGS. 3 and 4.

The respective components provided over the counter substrate 202 will be described below.

As shown in FIGS. 3 and 4, the color filter layer 21 is formed on the surface of the counter substrate 202 opposed to the TFT array substrate 201. Although not shown in the diagrams, the color filter layer 21 is provided for each pixel P in such a way that filters of three primary colors of red, green, and blue are combined into one set, and the respective colors are arranged along the x direction. The color filter layer 21 is formed by using e.g. a polyimide resin containing a colorant such as a pigment or a dye. White light emitted from the backlight 300 is colored by the color filter layer 21 and then output therefrom.

As shown in FIG. 4, a black matrix layer 21K is so provided around the color filter layer 21 as to define the color filter layer 21 of each color. This black matrix layer 21K is formed of e.g. a resin layer containing a black pigment and blocks light.

As shown in FIGS. 3 and 4, a planarizing film 22 covers the surface of each of the color filter layer 21 and the black matrix layer 21K opposed to the TFT array substrate 201. This planarizing film 22 is formed by using an optically-transparent insulating material and planarizes the side of the surface of the counter substrate 202 opposed to the TFT array substrate 201.

As shown in FIGS. 3 and 4, the counter electrode 23 is formed over the surface of the counter substrate 202 opposed to the TFT array substrate 201. The counter electrode 23 covers the planarizing film 22. The counter electrode 23 is a so-called transparent electrode and is formed by using e.g. ITO. As shown in FIG. 6, the counter electrode 23 is electrically connected to a Vcom line CL, and a common potential is applied thereto. That is, the counter electrode 23 is opposed to each of the plural pixel electrodes 62p formed corresponding to the plural pixels P in the display area PA, and functions as a common electrode common to the respective pixels P.

As shown in FIGS. 3 and 4, a liquid crystal alignment film HM2 is provided on the counter electrode 23. In the present embodiment, the liquid crystal alignment film HM2 covers the entire surface of the counter electrode 23. For example, the liquid crystal alignment film HM2 is formed by using polyimide.

As shown in FIG. 4, the touch electrode 25 is provided on the liquid crystal alignment film HM2 over the counter substrate 202. The touch electrode 25 is provided above the part of the counter substrate 202 opposed to the elastic member 63 provided over the TFT array substrate 201.

As shown in FIG. 6, this touch electrode 25 is electrically connected to the Vcom line CL. In the present embodiment, as shown in FIG. 5A, the Vcom line CL extends along the x direction above the gate line GL, and the touch electrode 25 is formed monolithically with this Vcom line CL.

This touch electrode 25 functions as the touch sensor SWs together with the touch electrode 62t provided over the TFT array substrate 201 as shown in FIGS. 4, 5A, 5B, and 6.

Specifically, as shown in FIG. 6, the touch sensor SWs is a two-terminal switch having no control terminal, and is provided in parallel to the capacitor including the liquid crystal layer 203 as a dielectric substance in the equivalent circuit. The touch sensor SWs is so configured as to be set to the on-state if the counter substrate 202 is pushed and deformed by e.g. a human finger and thereby the pair of touch electrodes 62t and 25 are brought into contact with each other.

Details of the liquid crystal layer 203 will be described below.

As shown in FIGS. 3 and 4, the liquid crystal layer 203 is sandwiched between the TFT array substrate 201 and the counter substrate 202.

In the present embodiment, liquid crystal molecules (not shown) in the liquid crystal layer 203 are aligned by the liquid crystal alignment film HM1 formed over the TFT array substrate 201 and the liquid crystal alignment film HM2 formed over the counter substrate 202. For example, the liquid crystal layer 203 is so formed that the liquid crystal molecules are vertically aligned.

As shown in FIG. 6, this liquid crystal layer 203 provides a capacitor together with the pixel electrode 62p over the TFT array substrate 201 and the counter electrode 23 over the counter substrate 202.

### (Operation)

Description will be made below about operation in detection of the position at which the sensing target F such as a finger of the user gets contact with the display area PA of the liquid crystal panel 200 in the above-described liquid crystal display device 100.

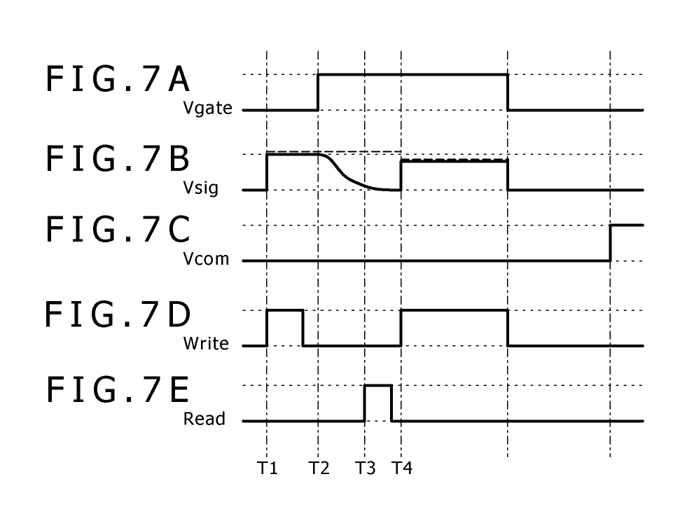

FIGS. 7A to 7E are waveform diagrams of control signals supplied to the respective components by the controller 401 when the liquid crystal display device 100 according to the first embodiment of the present invention is operated. FIG. 7A shows the scan signal (Vgate) supplied to the gate line GL. FIG. 7B shows a data signal (Vsig) supplied to the signal line SL. FIG. 7C is a waveform diagram of the common voltage (Vcom) supplied to the Vcom line CL. FIG. 7D shows the write signal (Write) supplied to the switch SWw. FIG. 7E shows the read signal (Read) supplied to the switch SWr.

First, at T1, the data signal (Vsig) and the write signal (Write) are turned from the low level to the high level as shown in FIGS. 7B and 7D. Thus, the switch SWw is turned on by the write signal (Write) at the high level, and the data signal (Vsig) at the high level is supplied from the write circuit WC to the signal line SL via the switch SWw (see FIG. 6).

Subsequently, before T2, as shown in FIG. 7D, the write signal (Write) is turned to the low level and the switch SWw is turned off, so that the signal line SL enters the floating state. In this state, at T2, the scan signal (Vgate) is turned from the low level to the high level as shown in FIG. 7A. Thus, the gate of the pixel switching element 31 enters the on-state, so that the channel is formed and the discharge path for the charge of the data signal (Vsig) is generated in the pixel switching element 31 (see FIG. 6).

At this time, if the touch sensor SWs is turned to the on-state, the charge of the signal line SL in the floating state is discharged to the Vcom line CL having high capacity. Thus, the potential of the data signal (Vsig) is lowered to a large extent as shown by the full line in FIG. 7B.

On the other hand, if the touch sensor SWs is in the off-state, the potential of the data signal (Vsig) is substantially kept and hardly changes as shown by the dashed line in FIG. 7B.

Subsequently, at T3, the read signal (Read) is turned from the low level to the high level as shown in FIG. 7E. Thus, the switch SWr is turned on by the read signal (Read) at the high level, and the data signal (Vsig) is read out from the signal line SL to the readout circuit RC via the switch SWr (see FIG. 6).

At this time, if the touch sensor SWs is in the on-state, the data signal (Vsig) of the lower potential is read out as shown by the full line in FIG. 7B. On the other hand, if the touch sensor SWs is in the off-state, the data signal (Vsig) of the higher potential is read out as shown by the dashed line in FIG. 7B.

Furthermore, at this time, the position detector 402 (see FIG. 1) in the data processor 400 carries out position detection based on the potential of this read data signal (Vsig).

Specifically, the position detector 402 executes processing of comparison between the potential of the read data signal (Vsig) and the reference potential. If the potential of the read data signal (Vsig) is higher than the reference potential, the position detector 402 determines that the touch sensor SWs is in the off-state. On the other hand, if the potential of the read data signal (Vsig) is lower than the reference potential, the position detector 402 determines that the touch sensor SWs is in the on-state. The position detector 402 detects the position of the pixel P whose touch sensor SWs is regarded as being in the on-state by the determination as the position with which the sensing target F such as a finger gets contact.

That is, the position detector 402 detects the position at which the sensing target F such as a finger gets contact with the liquid crystal panel 200 based on the potential changing between the potential obtained when the touch sensor SWs is in the on-state and the potential obtained when it is in the off-state.

Subsequently, at T4, the read signal (Read) is turned to the low level to thereby set the switch SWr to the off-state as shown in FIG. 7E. Subsequently, the write signal (Write) is turned from the low level to the high level to thereby set the switch SWw to the on-state. In addition, the data signal (Vsig) at the high level is applied to the signal line SL. Thereafter, the potential of the common voltage Vcom is inverted and the control of the displaying is continued.

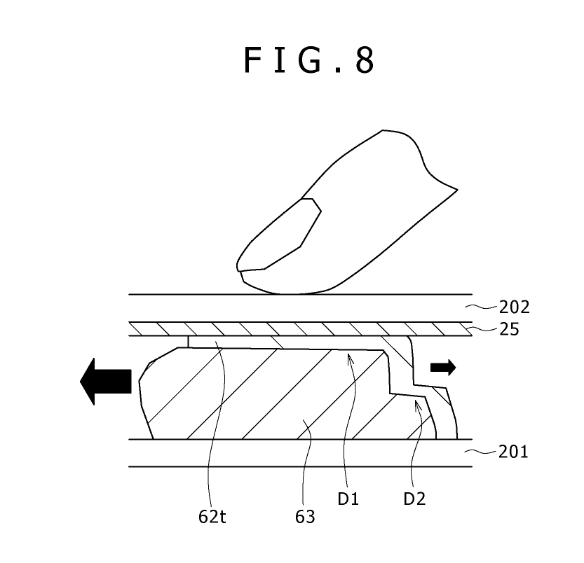

FIG. 8 is a sectional view showing the appearance when the sensing target F gets contact with the display area PA of the liquid crystal panel 200 in the liquid crystal display device 100 according to the first embodiment of the present invention. In FIG. 8, a major part is shown whereas illustration of part of the components is omitted.

As shown in FIG. 8, if the sensing target F gets contact with the surface of the counter substrate 202 on the opposite side to the liquid crystal layer 203 and the counter substrate 202 is pushed, the counter substrate 202 is deformed and moves toward the TFT array substrate 201. At this time, along with the deformation of the counter substrate 202, the touch electrode 25 provided on the surface of the counter substrate 202 on the side of the liquid crystal layer 203 is moved toward the TFT array substrate 201. As a result, this touch electrode 25 gets contact with the touch electrode 62t provided over the TFT array substrate 201. Due to the contact of the touch electrode 25 provided over the counter substrate 202 with the touch electrode 62t provided over the TFT array substrate 201 in this manner, the touch sensor SWs enters the on-state.

As shown in FIG. 8, when the pair of touch electrodes 62t and 25 are brought into contact with each other, the elastic member 63 is deformed due to the pushing by the sensing target F. Thus, along with the deformation of the elastic member 63, stress in directions along the xy plane is applied to the touch electrode 62t, which possibly causes the breaking of the touch electrode 62t.

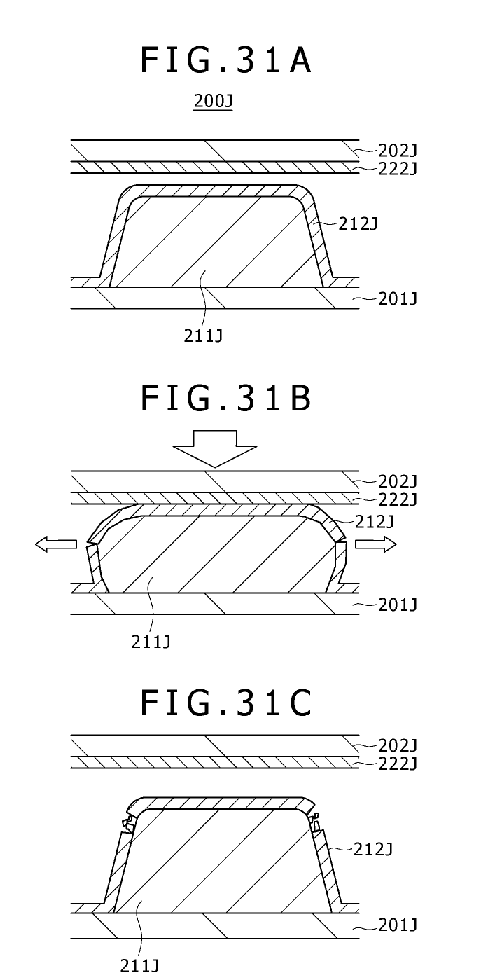

However, in the present embodiment, the plural steps D1 and D2 are provided in the elastic member 63. Therefore, the stress accompanying the deformation of the elastic member 63 is dispersed as is apparent from comparison with the above-described case of FIG. 31. Thus, high stress is not applied to the touch electrode 62t formed on the elastic member 63.

Consequently, in the present embodiment, the breaking of the touch electrode 62t formed on the elastic member 63 can be prevented.

### (Manufacturing Method)

A method for forming the elastic member 63 in the above-described liquid crystal display device 100 will be described below.

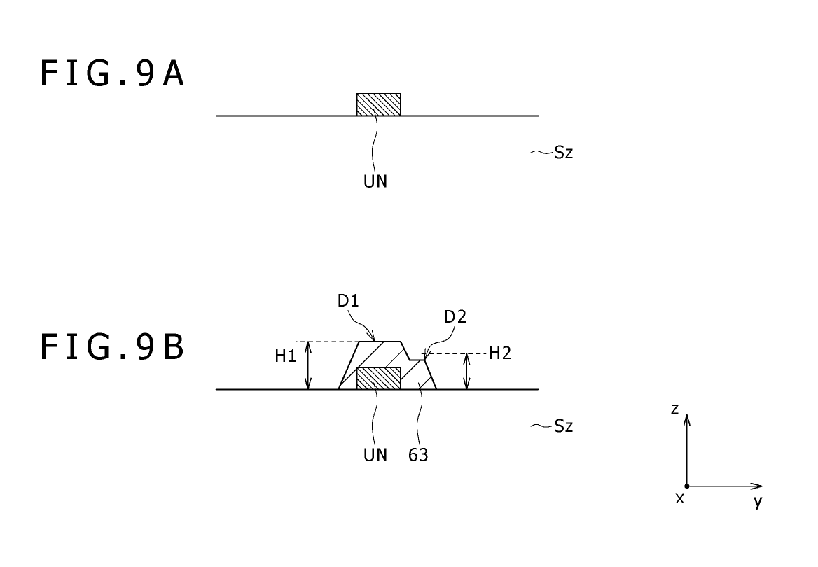

FIGS. 9A and 9B are sectional views showing steps for forming the elastic member 63 in the first embodiment of the present invention. In FIGS. 9A and 9B, a major part is shown whereas illustration of part of the components is omitted.

First, as shown in FIG. 9A, an underlying layer UN is formed.

In this step, a photosensitive resin film (not shown) is so formed on the interlayer insulating film Sz as to cover the area in which the elastic member 63 is to be formed. Thereafter, the photosensitive resin film is pattern-processed by a photolithography technique, to thereby form the underlying layer UN.

In the present embodiment, the underlying layer UN is formed on the area above which the higher step D1, of the plural steps D1 and D2 formed in the elastic member 63, is to be formed.

Subsequently, as shown in FIG. 9B, the elastic member 63 is formed.

In this step, a photosensitive resin film (not shown) is so formed on the underlying layer UN as to cover the area in which the elastic member 63 is to be formed. Thereafter, the photosensitive resin film is pattern-processed by a photolithography technique, to thereby form the elastic member 63.

Subsequently, the pixel electrode 62p and the touch electrode 62t are so formed as to include the part covering the elastic member 63 as described above.

### (Summary)

As above, in the present embodiment, the liquid crystal panel 200 has the built-in touch sensor SWs of the “contact type,” in which readout is carried out based on voltage change responding to contact between the electrodes. The touch sensor SWs includes the touch electrode 62t formed on the elastic member 63 over the TFT array substrate 201 and the touch electrode 25 provided over the counter substrate 202 as the pair of electrodes. This touch sensor SWs is so configured that the pair of touch electrodes 62t and 25 are brought into contact with each other when the liquid crystal panel 200 is deformed by external pressure. In the present embodiment, in the elastic member 63, the plural steps D1 and D2 are formed in the z direction perpendicular to the xy plane of the TFT array substrate 201. Specifically, the elastic member 63 is so formed as to include the first step D1 formed with the first height H1 as the largest height and the second step D2 formed with the second height H2 lower than the first height H1. The touch electrode 62t is so provided as to cover the surface of the plural steps D1 and D2 of the elastic member 63. That is, the touch electrode 62t is so provided on the elastic member 63 as to include the part covering the surface of the first step D1 and the second step D2.

As shown in FIG. 8, in the present embodiment, if external pressure that makes the pair of touch electrodes 62t and 25 get contact with each other is applied, the first step D1 of the elastic member 63 is deformed to a large extent but the second step D2 of the elastic member 63 is not deformed to a large extent. Thus, the part of the touch electrode 62t provided on the second step D2 of the elastic member 63 is less deformed due to the external pressure. Therefore, the breaking of the touch electrode 62t can be prevented without increasing the area of the surface of the elastic member 63 with which the touch electrode 25 gets contact.

Consequently, the present embodiment can realize enhancement in the image quality and enhancement in the device reliability.

Furthermore, in the elastic member 63 of the present embodiment, the area of the higher first step D1 is larger than that of the lower second step D2 (see FIG. 5B and so on). Specifically, of the plural steps D1 and D2 formed in the elastic member 63, the step D1 located at the top surface is wider than the other step. Because the first step D1, with which the touch electrode 25 provided over the counter substrate 202 is brought into direct contact, has an area larger than that of the second step D2 in the elastic member 63, pressure is less concentrated on the first step D1 when external pressure is applied. Thus, the above-described advantageous effect can be exerted to a higher degree.

In addition, in the present embodiment, the touch electrode 25 is formed on the liquid crystal alignment film HM2. Therefore, the electric resistance arising at the time of the contact is low, which allows detection of the contact position with high sensitivity.

Moreover, in the present embodiment, the touch electrode 62t is formed monolithically with the pixel electrode 62p. Therefore, the aperture ratio of the liquid crystal panel 200 can be enhanced and thus the quality of displayed images can be enhanced.

### 2. Second Embodiment

### The Position of the Lower Step of the Elastic Member is at the Center in Top View

A second embodiment of the present invention will be described below.

### (Detailed Configuration of Liquid Crystal Panel)

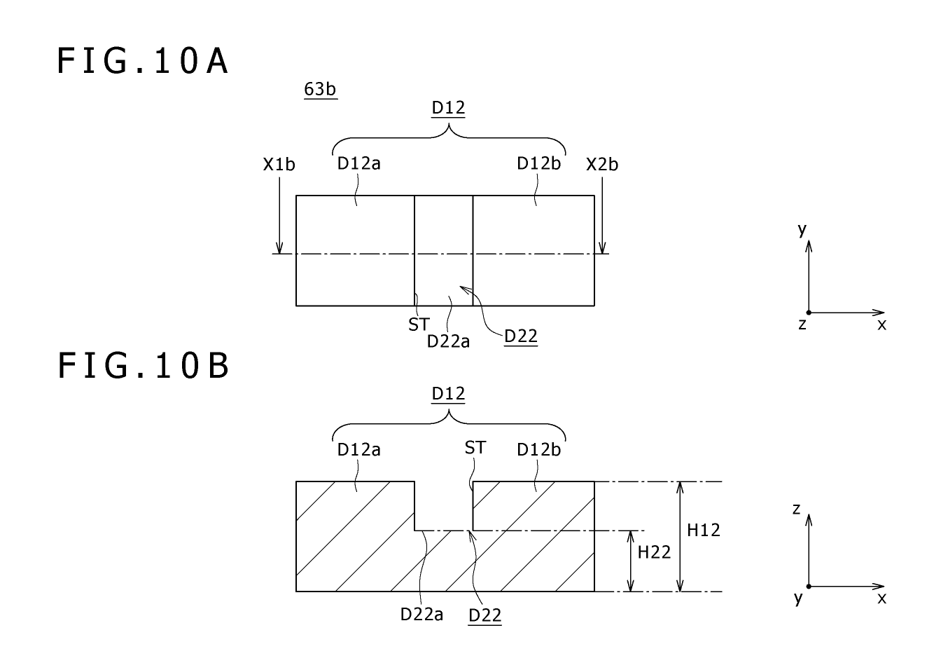

FIGS. 10A and 10B are diagrams showing an elastic member 63b in an enlarged manner in a liquid crystal display device according to the second embodiment of the present invention. FIG. 10A is a top view, and FIG. 10B is a sectional view along line X1b-X2b in FIG. 10A.

As shown in FIGS. 10A and 10B, in the present embodiment, the shape of the elastic member 63b is different from that of the elastic member 63 in the first embodiment. Except for this point and points relating thereto, the second embodiment is the same as the first embodiment. Therefore, description of the overlapping part is omitted.

As shown in FIGS. 10A and 10B, in the elastic member 63b, plural steps D1 and D2 are provided by a slit formed into a recess shape.

As shown in FIG. 10A, the elastic member 63b has a rectangular shape in the xy plane and is so formed that the sides thereof along the x direction are longer than the sides thereof along the y direction. At the center part in the x direction, a slit ST extending along the y direction is provided.

As shown in FIG. 10B, in the xz plane, the elastic member 63b is so formed as to include a first step D12 having a first height H12 and a second step D22 having a second height H22 lower than the first height H12.

Specifically, as shown in FIG. 10A, the first step D12 of the elastic member 63b includes a pair of surfaces D12a and D12b in the xy plane, and the pair of surfaces D12a and D12b sandwich the second step D22. The second step D22 of the elastic member 63b includes a rectangular surface D22a extending along the y direction in the xy plane, and this surface D22a is sandwiched between the respective surfaces D12a and D12b of the first step D12 along the x direction.

Although not shown in the diagram, the touch electrode 62t is so provided on the elastic member 63b as to include the part covering the surface of the plural steps similarly to the first embodiment. That is, the touch electrode 62t is so provided on the elastic member 63b as to include the part covering the surface of the first step D12 and the second step D22.

### (Manufacturing Method)

A method for forming the above-described elastic member 63b will be described below.

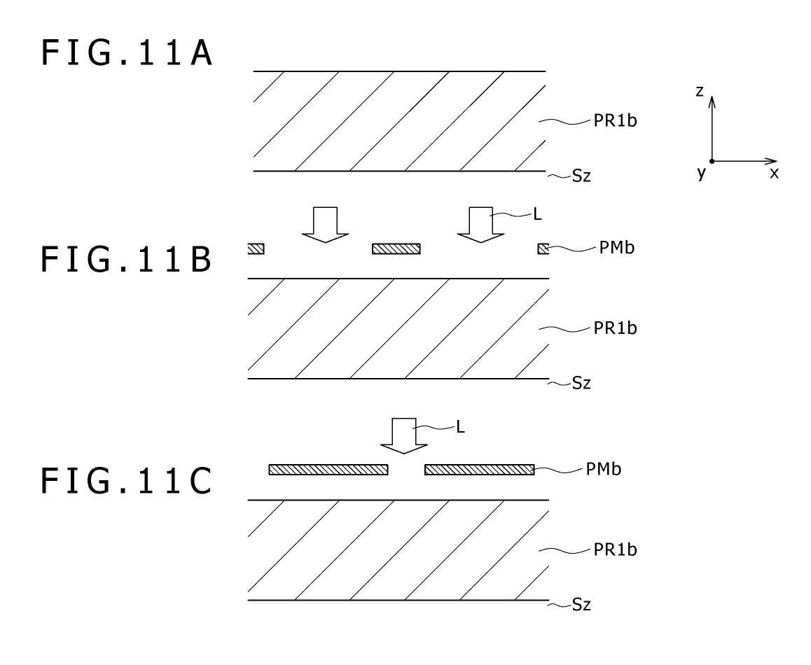

FIGS. 11A to 11C are sectional views showing steps for forming the elastic member 63b in the second embodiment of the present invention. In FIGS. 11A to 11C, a major part is shown whereas illustration of part of the components is omitted.

First, as shown in FIG. 11A, a photosensitive resin film PR1b is formed.

In this step, the photosensitive resin film PR1b is so formed as to cover the area in which the elastic member 63b is to be formed. In the present embodiment, this photosensitive resin film PR1b is formed by using a negative photoresist material (e.g. NN series made by JSR Corporation).

Subsequently, as shown in FIG. 11B, exposure treatment for the photosensitive resin film PR1b is performed.

In this step, this exposure treatment is performed by irradiating the photosensitive resin film PR1b with exposure light L via a photomask PMb having a mask pattern. In the present embodiment, the photomask PMb has such a mask pattern that the exposure light L passes through the part corresponding to the first step D12 of the elastic member 63b whereas the exposure light L is blocked by the part corresponding to the second step D22.

Thereafter, development treatment is performed to thereby complete the elastic member 63b shown in FIGS. 10A and 10B.

If the photosensitive resin film PR1b is formed by using a positive photoresist material (e.g. a PC resin made by JSR Corporation), exposure treatment shown in FIG. 11C is performed to form the elastic member 63b.

In this case, as shown in FIG. 11C, the photomask PMb is used with such a mask pattern that the exposure light L is blocked by the part corresponding to the first step D12 of the elastic member 63b whereas the exposure light L passes through the part corresponding to the second step D22.

### (Summary)

As above, in the present embodiment, the plural steps D12 and D22 are formed in the elastic member 63b in the z direction perpendicular to the xy plane of the TFT array substrate 201. Specifically, the elastic member 63b is so formed as to include the first step D12 formed with the first height H12 as the largest height and the second step D22 formed with the second height H22 lower than the first height H12. A pixel electrode 62pb is so provided as to cover the surface of the plural steps D12 and D22 of the elastic member 63b. That is, the pixel electrode 62pb is so provided on the elastic member 63b as to include the part covering the surface of the first step D12 and the second step D22.

Therefore, similarly to the first embodiment, the elastic member 63b shows a reduced tendency to be deformed by external pressure, and thus the breaking of the pixel electrode 62pb can be prevented without increasing the area of the surface of the elastic member 63b with which the touch electrode 25 gets contact.

In particular, in the present embodiment, the plural steps D1 and D2 are provided in the elastic member 63b by the slit formed into a recess shape. Therefore, the deformation of the elastic member 63b can be effectively suppressed.

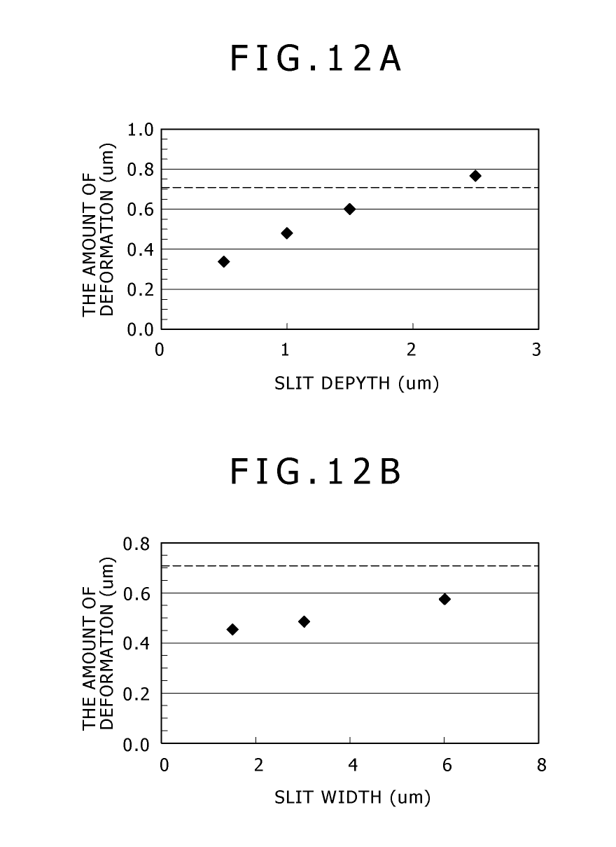

FIGS. 12A and 12B are diagram showing the amount of deformation in the step part of the elastic member 63b in the second embodiment of the present invention.

FIG. 12A shows results obtained when the width of the slit ST is fixed at 3 μm and the slit depth is varied. On the other hand, FIG. 12B shows results obtained when the depth of the slit ST is fixed at 1 μm and the slit width is varied.

As shown in FIGS. 12A and 12B, the amount of deformation is smaller when the slit is provided in the elastic member 63b than when the slit is not provided (the dotted line in FIGS. 12A and 12B). Preferable results were obtained when the depth of the slit was in the range of 0.5 to 1.5 μm, and the shallower slit offered a more preferable result. Furthermore, preferable results were obtained when the width of the slit was in the range of 1.5 to 6 μm, and the smaller width offered a more preferable result.

These amounts of deformation resulted from simulation performed under the following conditions.

the Young's modulus of the elastic member 63b: 3.5 GPa

the Poisson's ratio of the elastic member 63b: 0.38

the taper angle of the elastic member 63b: 60°

the size of the elastic member 63b

the length of the longer sides in the xy plane: 35 μm (calculated with 35 μm)

the length of the shorter sides in the xy plane: 15 μm (calculated with 15 μm)

the height: 2.5 μm

applied pressure: 1.1×10⁹ Pa

As above, in the present embodiment, the amount of deformation is small in the step part of the elastic member 63b, and thus the breaking of the pixel electrode 62pb can be prevented.

Consequently, the present embodiment can realize enhancement in the image quality and enhancement in the device reliability.

### 3. Third Embodiment

### The Planar Shape of the Lower Step of the Elastic Member is a Triangle

A third embodiment of the present invention will be described below.

### (Detailed Configuration of Liquid Crystal Panel)

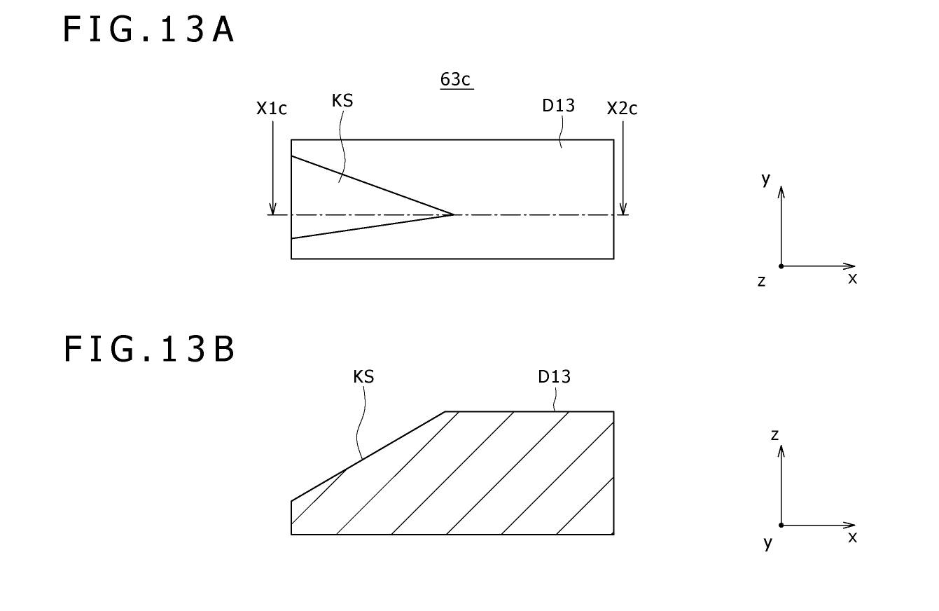

FIGS. 13A and 13B are diagrams showing an elastic member 63c in an enlarged manner in a liquid crystal display device according to the third embodiment of the present invention. FIG. 13A is a top view, and FIG. 13B is a sectional view along line X1c-X2c in FIG. 13A.

In the present embodiment, the shape of the elastic member 63c is different from that of the elastic member 63 in the first embodiment. Except for this point and points relating thereto, the third embodiment is the same as the first embodiment. Therefore, description of the overlapping part is omitted.

As shown in FIGS. 13A and 13B, the elastic member 63c is so formed as to include an inclined surface KS inclined to the xy plane of the TFT array substrate 201.

In the present embodiment, as shown in FIG. 13A, the elastic member 63c has a rectangular shape in the xy plane and is so formed that the sides thereof along the x direction are longer than the sides thereof along the y direction.

Furthermore, as shown in FIG. 13B, in the xz plane, the elastic member 63c includes a surface D13 along the xy plane and the inclined surface KS is provided at one end of the surface D13. This inclined surface KS is so formed that the width of its section in the xz plane perpendicular to the xy plane of the TFT array substrate 201 (the width in the x direction) becomes smaller as the position gets farther away from the xy plane toward the upper side in the z direction as shown in FIG. 13B.

In addition, as shown in FIG. 13A, this inclined surface KS is so formed that, in the xy plane parallel to the surface of the TFT array substrate 201, the width of the inclined surface KS (the width in the y direction) becomes larger along the direction from the inner side to the outer side. That is, the inclined surface KS is so formed that its shape in the xy plane is a triangular shape as shown in FIG. 13A.

Moreover, although not shown in the diagram, the touch electrode 62t is so provided on the elastic member 63c as to include the part covering these plural surfaces D13 and KS similarly to the first embodiment. That is, the touch electrode 62t is formed on the plural surfaces D13 and KS having different heights in the elastic member 63c.

### (Manufacturing Method)

A method for forming the above-described elastic member 63c will be described below.

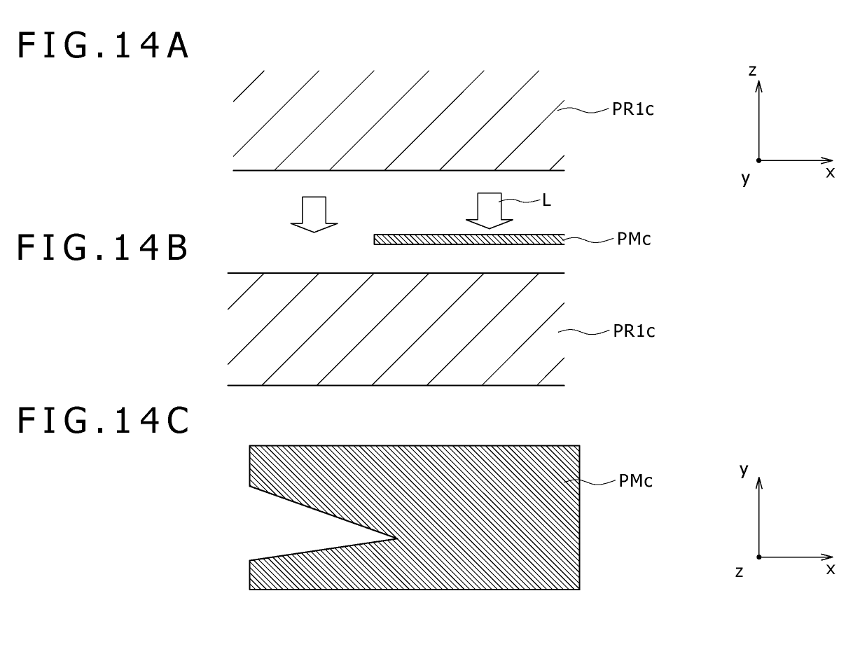

FIGS. 14A to 14C are sectional view showing steps for forming the elastic member 63c in the third embodiment of the present invention. In FIGS. 14A to 14C, a major part is shown whereas illustration of part of the components is omitted.

First, as shown in FIG. 14A, a photosensitive resin film PR1c is formed.

In this method, the photosensitive resin film PR1c is so formed as to cover the area in which the elastic member 63c is to be formed. In the present embodiment, this photosensitive resin film PR1c is formed by using a positive photoresist material (e.g. a PC resin made by JSR Corporation).

Subsequently, as shown in FIG. 14B, exposure treatment is performed for the photosensitive resin film PR1c.

In this step, this exposure treatment is performed by irradiating the photosensitive resin film PR1c with exposure light L via a photomask PMc having a mask pattern.

In the present embodiment, as shown in FIG. 14C, the photomask PMc has such a mask pattern that the exposure light L passes through the part corresponding to the inclined surface KS of the elastic member 63c whereas the exposure light is blocked by the other part. That is, the photomask PMc in which a triangular aperture is provided as the mask pattern is used.

In this case, part whose width is smaller than the limit of resolution exists in the triangular aperture. Therefore, the depth of the exposure changes depending on the width as described above.

Thus, by performing development treatment after this exposure treatment, the elastic member 63c including the inclined surface KS is completed as shown in FIGS. 13A and 13B.

### (Summary)

As described above, in the present embodiment, the inclined surface KS is formed in the elastic member 63c. Furthermore, a pixel electrode 62pb is so provided as to cover the surface of the inclined surface KS.

Thus, similarly to the first embodiment, the elastic member 63c shows a reduced tendency to be deformed by external pressure, and thus the breaking of the pixel electrode 62pb can be prevented without increasing the area of the surface of the elastic member 63c with which the touch electrode 25 gets contact.

In particular, in the present embodiment, the inclined surface KS is provided in the elastic member 63c, and thus the deformation of the elastic member 63c can be effectively suppressed.

Consequently, the present embodiment can realize enhancement in the image quality and enhancement in the device reliability.

### 4. Fourth Embodiment

### The Elastic Member has Three Steps

A fourth embodiment of the present invention will be described below.

### (Detailed Configuration of Liquid Crystal Panel)

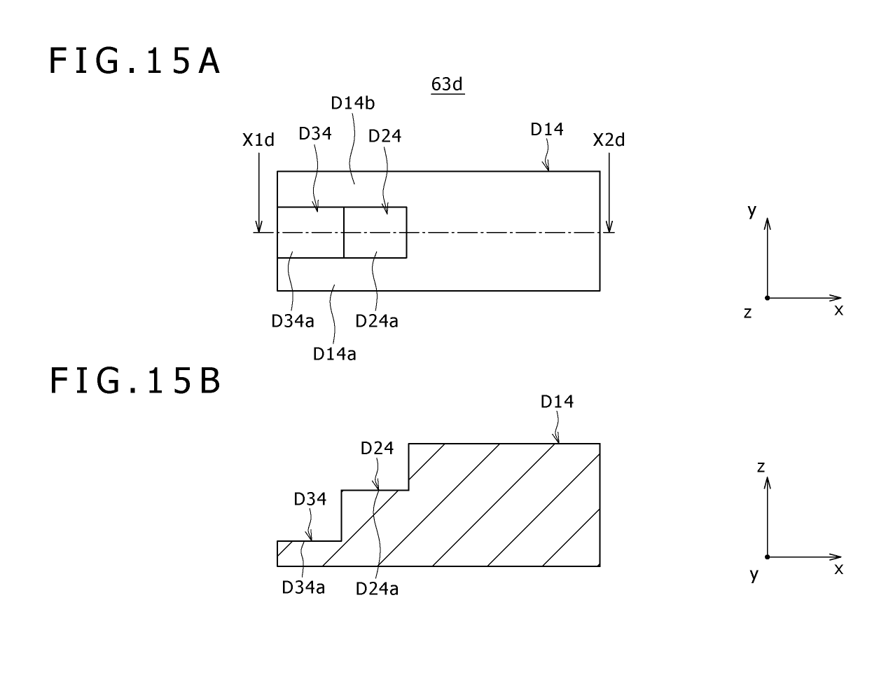

FIGS. 15A and 15B are diagrams showing an elastic member 63d in an enlarged manner in a liquid crystal display device according to the fourth embodiment of the present invention. FIG. 15A is a top view, and FIG. 15B is a sectional view along line X1d-X2d in FIG. 15A.

As shown in FIGS. 15A and 15B, in the present embodiment, the shape of the elastic member 63d is different from that of the elastic member 63 in the first embodiment. Except for this point and points relating thereto, the fourth embodiment is the same as the first embodiment. Therefore, description of the overlapping part is omitted.

As shown in FIGS. 15A and 15B, plural steps D14, D24, and D34 are provided in the elastic member 63d.

In the present embodiment, as shown in FIG. 15A, the elastic member 63d has a rectangular shape in the xy plane and is so formed that the sides thereof along the x direction are longer than the sides thereof along the y direction. At the center part in the y direction, a slit extending along the x direction is provided.

As shown in FIG. 15B, in the xz plane, the elastic member 63d includes, in its slit part, a first step D14 having a first height H14 and a second step D24 having a second height H24 lower than the first height H14. In addition, the elastic member 63d further includes a third step D34 having a third height H34 lower than the second height H24. In this manner, the plural steps D14, D24, and D34 are provided in a staircase manner.

Specifically, as shown in FIG. 15A, the first step D14 of the elastic member 63d includes a pair of surfaces D14a and D14b in the xy plane, and the pair of surfaces D14a and D14b sandwich the second step D24 and the third step D34 along the y direction. The second step D24 of the elastic member 63d includes a rectangular surface D24a extending along the x direction in the xy plane, and this surface D24a is sandwiched by the respective surfaces D14a and D14b of the first step D14. The third step D34 of the elastic member 63d includes a rectangular surface D34a extending along the x direction in the xy plane, and this surface D34a is sandwiched by the respective surfaces D14a and D14b of the first step D14.

Furthermore, although not shown in the diagram, the touch electrode 62t is so provided on the elastic member 63d as to include the part covering the surface of these plural steps similarly to the first embodiment. That is, the touch electrode 62t is so provided on this elastic member 63d as to include the part covering the surface of the first step D14, the second step D24, and the third step D34.

### (Manufacturing Method)

A method for forming the above-described elastic member 63d will be described below.

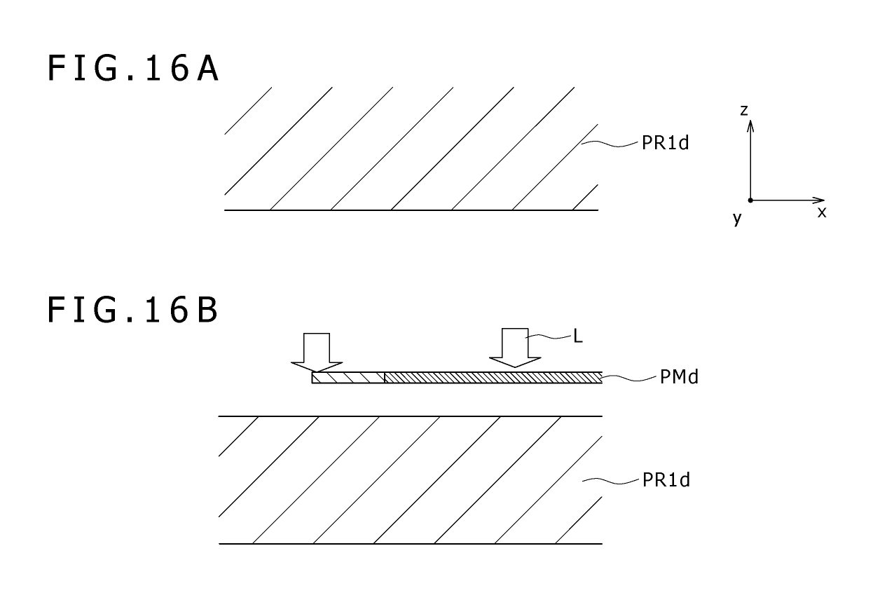

FIGS. 16A and 16B are sectional views showing steps for forming the elastic member 63d in the fourth embodiment of the present invention. In FIG. 16, a major part is shown whereas illustration of part of the components is omitted.

First, as shown in FIG. 16A, a photosensitive resin film PR1d is formed.

In this step, the photosensitive resin film PR1d is so formed as to cover the area in which the elastic member 63d is to be formed. In the present embodiment, this photosensitive resin film PR1d is formed by using a positive photoresist material.

Subsequently, as shown in FIG. 16B, exposure treatment is performed for the photosensitive resin film PR1d.

In this step, this exposure treatment is performed by irradiating the photosensitive resin film PR1d with exposure light L via a photomask PMd having a mask pattern. In the present embodiment, the photomask PMd has such a mask pattern that the exposure light L is blocked by the part corresponding to the first step D14 of the elastic member 63d whereas the exposure light L passes through the part corresponding to the third step D34. Furthermore, in the mask pattern of the photomask PMd, a halftone part is employed as the part corresponding to the second step D24 so that the exposure light L may pass through this part with intensity intermediate between that for the first step D14 and that for the third step D34.

Thereafter, by performing development treatment, the elastic member 63d shown in FIG. 15 is completed.

### (Summary)

As described above, in the present embodiment, the plural steps D14, D24, and D34 are formed in the elastic member 63d in the z direction perpendicular to the xy plane of the TFT array substrate 201. Furthermore, a pixel electrode 62pb is so provided as to cover the surface of the plural steps D14, D24, and D34 of the elastic member 63d.

Thus, similarly to the first embodiment, the elastic member 63d shows a reduced tendency to be deformed by external pressure, and thus the occurrence of breaking can be prevented without increasing the area of the surface of the elastic member 63d with which the touch electrode 25 gets contact.

### 5. Fifth Embodiment

### The Plural Steps of the Elastic Member are Provided Around a Contact

A fifth embodiment of the present invention will be described below.

### (Detailed Configuration of Liquid Crystal Panel)

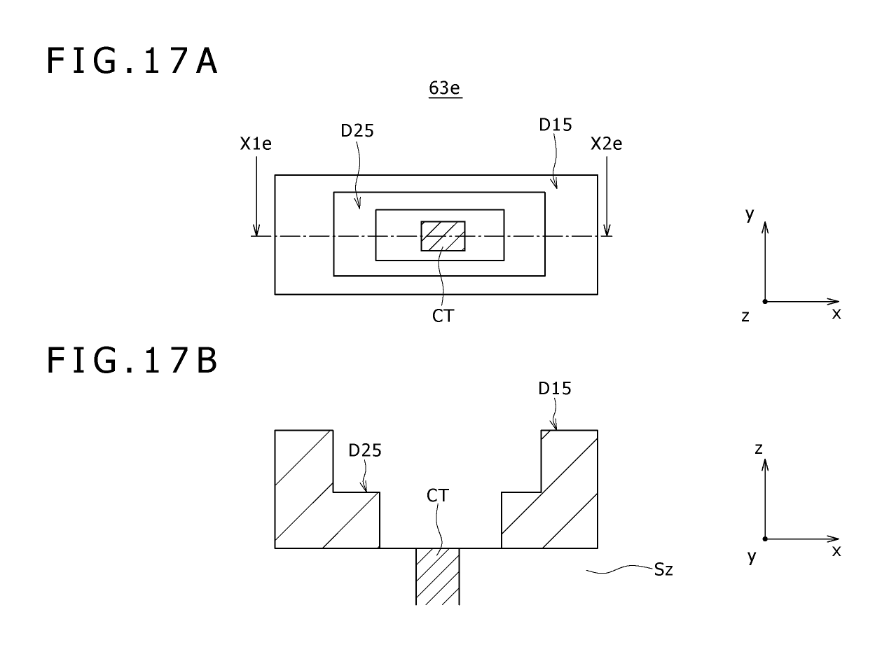

FIGS. 17A and 17B are diagrams showing an elastic member 63e in an enlarged manner in a liquid crystal display device according to the fifth embodiment of the present invention. FIG. 17A is a top view, and FIG. 17B is a sectional view along line X1e-X2e in FIG. 17A.

In the present embodiment, the shape of the elastic member 63e is different from that of the elastic member 63 in the first embodiment. Furthermore, the position of the elastic member 63e is different from that in the first embodiment. Except for this point and points relating thereto, the fifth embodiment is the same as the first embodiment. Therefore, description of the overlapping part is omitted.

As shown in FIGS. 17A and 17B, in the elastic member 63e, plural steps D15 and D25 are provided in the xy plane parallel to the surface of the TFT array substrate 201 in such a manner as to surround a contact CT.

In this embodiment, the steps D15 and D25 are provided around the whole of the contact CT electrically connected to the source/drain region (not shown) of the pixel switching element 31, although not shown in the diagram.

Furthermore, although not shown in the diagram, the touch electrode 62t is so provided on the elastic member 63e as to include the part covering the surface of the steps D15 and D25 similarly to the first embodiment, and is electrically connected to the contact CT.

### (Summary)

As described above, in the elastic member 63e of the present embodiment, the plural steps D15 and D25 are so provided as to surround the contact CT. Furthermore, the touch electrode 62t is so provided as to cover the surface of these plural steps D15 and D25 and is electrically connected to the contact CT.

Therefore, in the present embodiment, the occurrence of disconnection between the contact CT and the touch electrode 62t can be effectively prevented.

The shape of the elastic member in the fifth embodiment is not limited by the above-described case, in which the elastic member 63e has the plural steps D15 and D25 surrounding the whole of the contact CT in the xy plane.

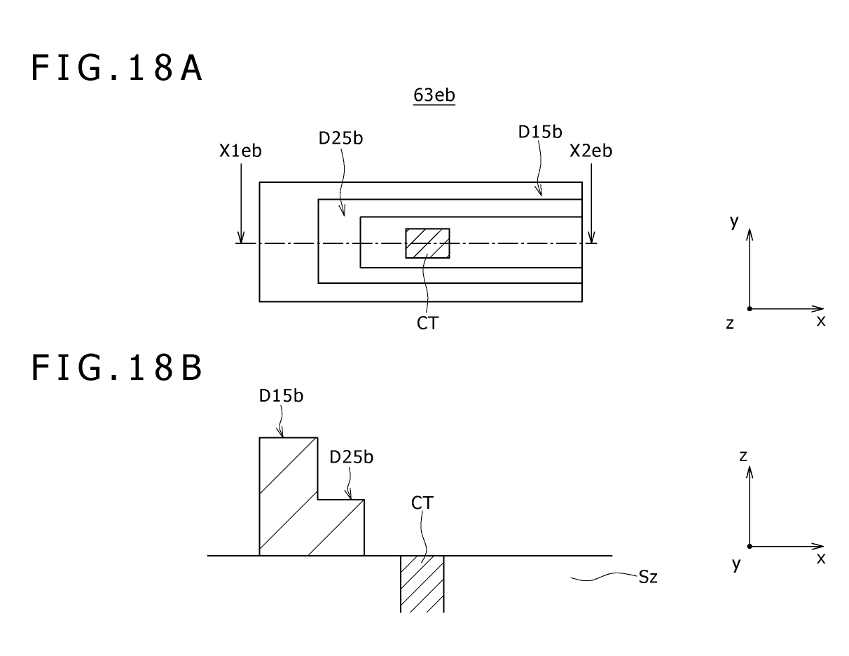

FIGS. 18A and 18B are diagrams showing an elastic member 63eb in an enlarged manner in a liquid crystal display device according to a modification example of the fifth embodiment of the present invention. FIG. 18A is a top view, and FIG. 18B is a sectional view along line X1eb-X2eb in FIG. 18A.

As shown in FIGS. 18A and 18B, for example, an elastic member 63eb may be so formed that plural steps D15b and D25b make a U-character around the contact CT.

### 6. Sixth Embodiment

### The Plural Steps of the Elastic Member are Provided by Stacking Plural Components

A sixth embodiment of the present invention will be described below.

### (Manufacturing Method)

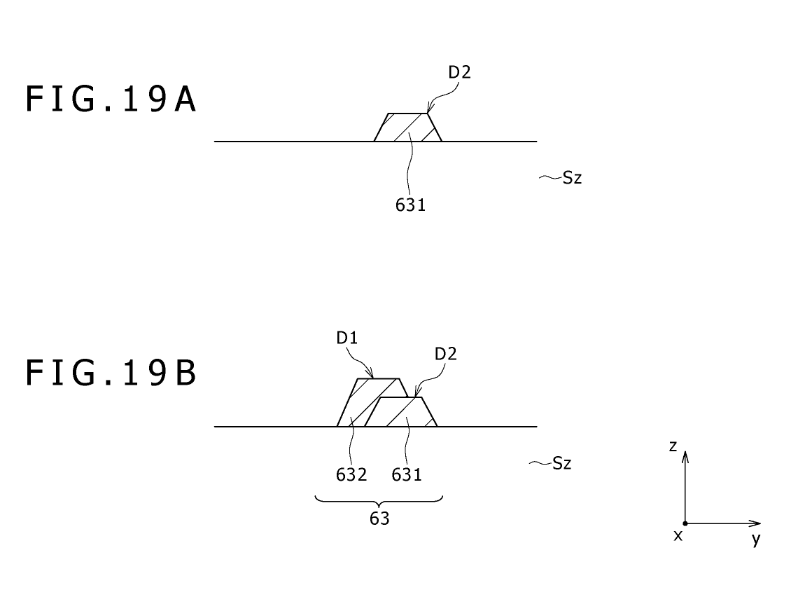

FIGS. 19A and 19B are sectional views showing steps for forming an elastic member 63 in the sixth embodiment of the present invention. In FIGS. 19A and 19B, a major part is shown whereas illustration of part of the components is omitted.

As shown in FIGS. 19A and 19B, the steps for forming the elastic member 63 in the present embodiment are different from those in the first embodiment. Except for this point and points relating thereto, the sixth embodiment is the same as the first embodiment. Therefore, description of the overlapping part is omitted.

In the formation of the elastic member 63, first, a first elastic member 631 is formed as shown in FIG. 19A.

In this step, the first elastic member 631 is so formed as to include the lower step D2 of the plural steps D1 and D2, which are to be formed in the elastic member 63, as shown in FIG. 19A.

Specifically, a first photosensitive resin film (not shown) is so formed as to cover the area in which the first elastic member 631 is to be formed. Thereafter, the first photosensitive resin film is pattern-processed by a photolithography technique, to thereby form the first elastic member 631.

Subsequently, as shown in FIG. 19B, a second elastic member 632 is formed.

In this step, the second elastic member 632 is so formed as to include the step D1 higher than the first elastic member 631, of the plural steps D1 and D2, which are to be formed in the elastic member 63, as shown in FIG. 19B.

Specifically, a second photosensitive resin film (not shown) is so formed on the first elastic member 631 as to cover the area in which the second elastic member 632 is to be formed. Thereafter, the second photosensitive resin film is pattern-processed by a photolithography technique, to thereby form the second elastic member 632.

Through the above-described steps, the first elastic member 631 and the second elastic member 632 are provided as the elastic member 63.

### (Summary)

By forming the elastic member 63 in the above-described manner, the touch electrode 62t can be so provided as to cover the surface of the plural steps D1 and D2 of the elastic member 63 similarly to the first embodiment. Thus, the present embodiment can realize enhancement in the image quality and enhancement in the device reliability similarly to the first embodiment.

### 7. Modification Examples

For carrying out the present invention, not only the above-described embodiments but also various modified forms can be employed.

### (1) Shape of Elastic Member

The shape of the elastic member is not limited to the above-described forms.

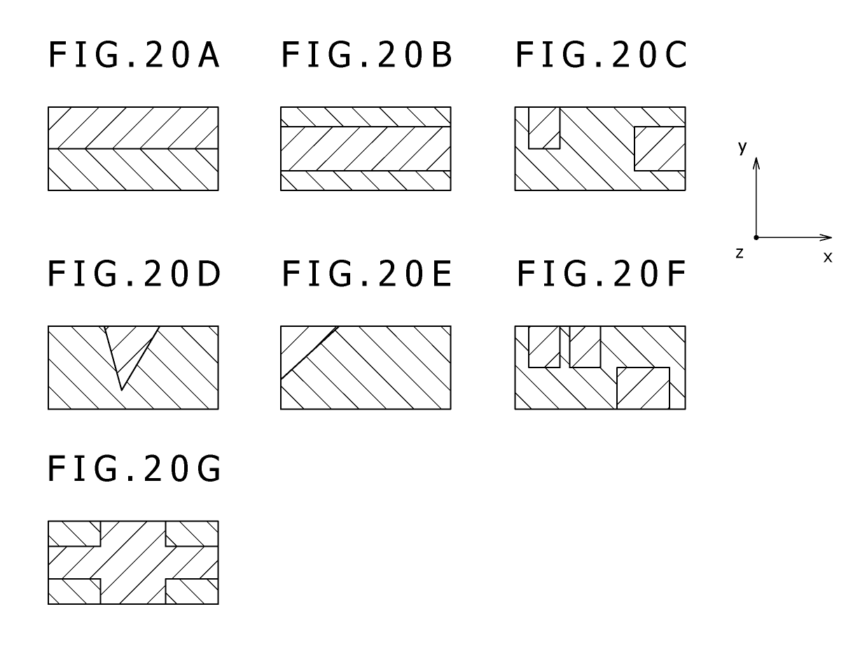

FIGS. 20A to 20G are diagrams showing elastic members in an enlarged manner in a liquid crystal display device according an embodiment of the present invention. In FIGS. 20A to 20G, each diagram is a top view and shows the lower-step part and the higher-step part by areas with different hatching patterns, respectively.

As shown in FIGS. 20A to 20G, plural steps with various shapes may be provided in the elastic member. For example, the plural steps may be formed by providing a slit traversing the surface of the elastic member or providing a groove at an end part. The shape of the elastic member can be arbitrarily designed depending on the shape and material of the touch electrode. As schemes other than the above-described ones, a trapezoidal elastic member may be employed or plural steps may be formed by providing gradation by a slit.

### (2) Entire Configuration of Liquid Crystal Panel

In the above-described liquid crystal panel 200, in order to keep the distance between the TFT array substrate 201 and the counter substrate 202, the spacer SP having the height corresponding to this distance is provided. However, a spacer SPL lower than this spacer SP may be separately provided.

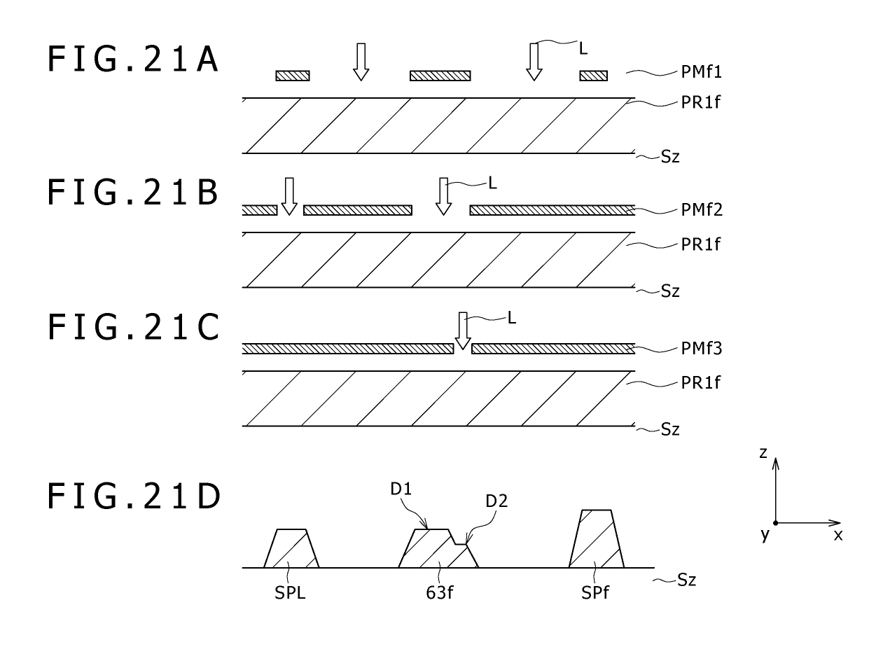

FIGS. 21A to 21D are sectional views showing steps for forming an elastic member 63f and the respective spacers SPf and SPL in an embodiment of the present invention. In FIGS. 21A to 21D, a major part is shown whereas illustration of part of the components is omitted.

In the formation of the respective components, exposure treatment for a photosensitive resin film PR1f is performed plural times sequentially as shown in FIGS. 21A, 21B, and 21C.

First, prior to this exposure treatment, the photosensitive resin film PR1f is formed.

In this step, the photosensitive resin film PR1f is so formed as to cover the area in which the elastic member 63f and the spacers SPf and SPL are to be formed. Specifically, this photosensitive resin film PR1f is formed by using a positive photoresist material.

Subsequently, as shown in FIG. 21A, exposure treatment is performed with use of a photomask PMf1.

In this step, exposure light L is so blocked that the area in which the elastic member 63f and the spacers SPf and SPL are to be formed in the photosensitive resin film PR1f is not irradiated with the exposure light L, whereas the other part is irradiated with the exposure light L.

Subsequently, as shown in FIG. 21B, exposure treatment is performed with use of a photomask PMf2.

In this step, the area in which the elastic member 63f and the spacer SPL are to be formed in the photosensitive resin film PR1f is irradiated with the exposure light L, and the exposure light L is blocked for the other part.

Subsequently, as shown in FIG. 21C, exposure treatment is performed with use of a photomask PMf3.

In this step, the area in which the lower second step D2 of the elastic member 63f is to be formed is irradiated with the exposure light L, and the exposure light L is blocked for the other part.

Thereafter, by performing development treatment, the elastic member 63f is completed as shown in FIG. 21D.

By collectively forming the elastic member 63f and the spacers SPf and SPL in this manner, the manufacturing efficiency can be enhanced.

(3) Application to Electrode Other than Touch Electrode

In the above-described embodiments, the touch electrode is formed on the elastic member having plural steps. However, embodiments of the present invention are not limited thereto. For example, the pixel electrode may be formed on the elastic member having plural steps.

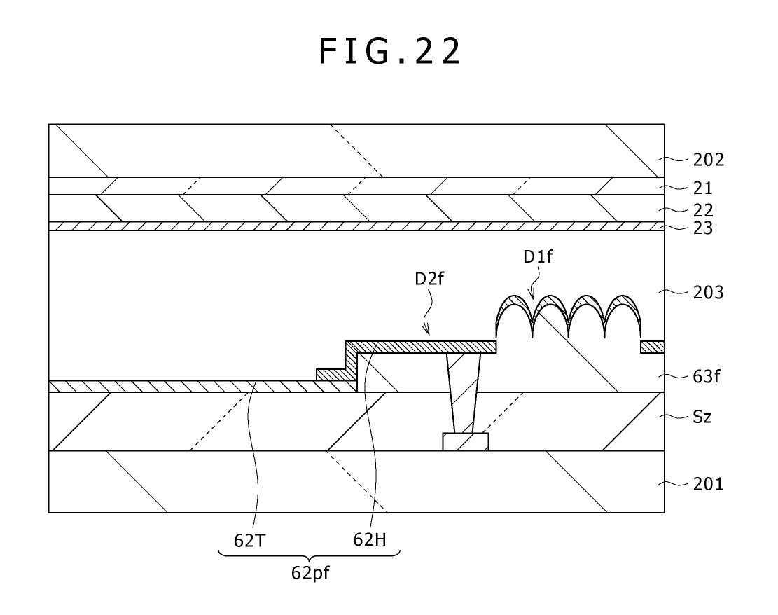

FIG. 22 is a sectional view schematically showing the rough configuration of a pixel provided in the display area in a liquid crystal panel according to an embodiment of the present invention.

In the present embodiment, the configuration of a pixel electrode 62pf is different from that of the pixel electrode 62p in the first embodiment. Except for this point and points relating thereto, the present embodiment is the same as the first embodiment. Therefore, a major part is shown and description of the other part is omitted.

As shown in FIG. 22, the pixel electrode 62p includes a transparent electrode 62T and a reflective electrode 62H and is electrically connected to the pixel switching element 31 via the contact CT. That is, the liquid crystal panel is formed as a semi-transmissive panel.

In the pixel electrode 62p, the transparent electrode 62T is formed on the interlayer insulating film Sz over the TFT array substrate 201 as shown in FIG. 22. The transparent electrode 62T is formed by using e.g. ITO and transmits light emitted from the backlight (not shown).

In the pixel electrode 62p, the reflective electrode 62H is formed on an elastic member 63f provided on the interlayer insulating film Sz over the TFT array substrate 201 as shown in FIG. 22. The reflective electrode 62H is formed by using e.g. Ag and reflects light incident on the side of the TFT array substrate 201 from the side of the counter substrate 202.

The elastic member 63f includes a first step D1f and a second step D2f having different heights in the z direction perpendicular to the xy plane of the TFT array substrate 201 as shown in FIG. 22.

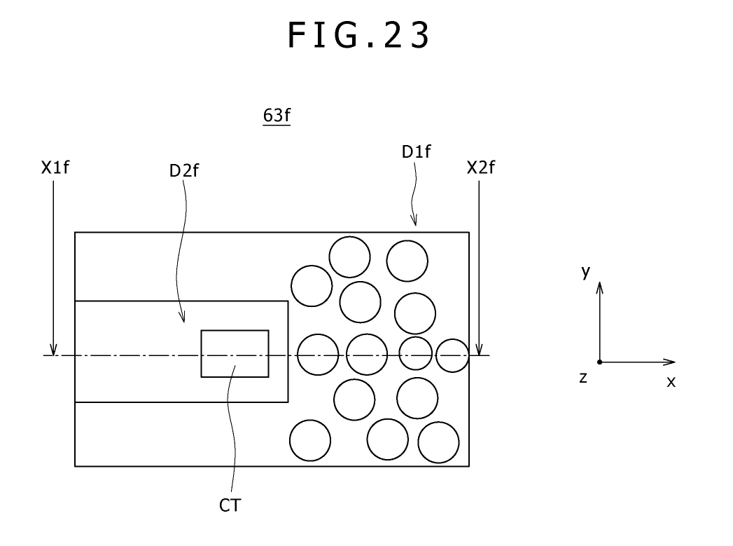

FIG. 23 is a top view of the elastic member 63f in the liquid crystal panel according to the embodiment of the present invention. FIG. 22 is a sectional view along line X1f-X2f in FIG. 23.

In the elastic member 63f, projections are formed on the surface of the first step D1f as shown in FIGS. 22 and 23. Furthermore, the first step D1f is so provided as to make a U-character around the contact CT as shown in FIG. 23.

On the other hand, in the elastic member 63f, the second step D2f is so formed as to be lower than the first step Df1 as shown in FIG. 22.

The reflective electrode 62H is so provided as to cover the surface of both of the first step D1f and the second step D2f.

Also in the above-described liquid crystal panel, when external pressure is applied, stress is applied to the reflective electrode 62H and the breaking thereof possibly occurs.

However, the elastic member 63f includes the plural steps D1f and D2f and the reflective electrode 62H is provided on these plural steps D1f and D2f. Thus, the occurrence of the above-described trouble can be prevented similarly to the case of the touch electrode 62t in the first embodiment.

Embodiments of the present invention are not limited to the case in which the elastic member 63f is provided on the side of the TFT array substrate 201.

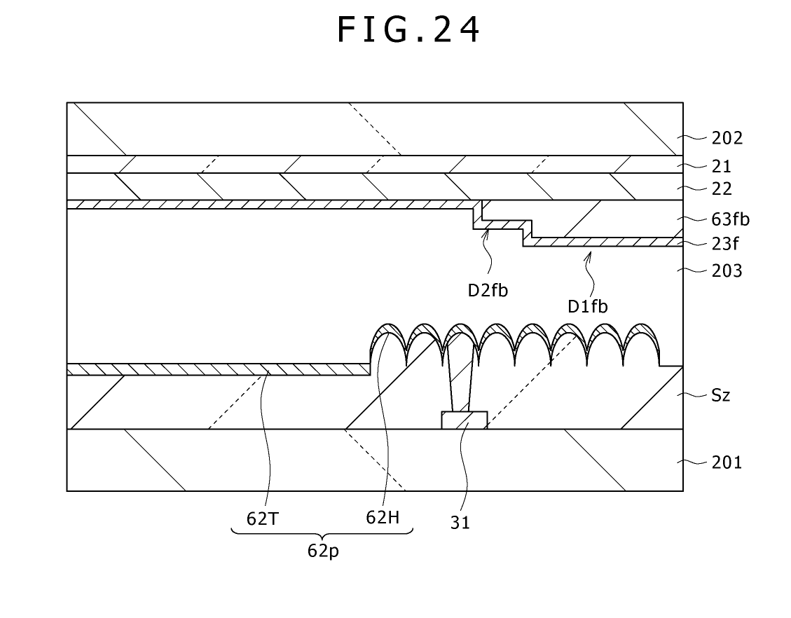

FIG. 24 is a sectional view schematically showing the rough configuration of a pixel P provided in a display area PA in a liquid crystal panel according to an embodiment of the present invention.

As shown in FIG. 24, an elastic member 63fb may be provided on the side of the counter substrate 202. Specifically, as shown in FIG. 24, a first step D1fb and a second step D2fb may be formed in the elastic member 63fb and a counter electrode 23f may be so formed as to cover the surface of the elastic member 63fb.

### (4) Formation of Plural Steps of Elastic Member

In the above-described first embodiment, the underlying layer UN is formed by using a photosensitive resin film in order to form the plural steps D1 and D2 in the elastic member 63 (see FIGS. 9A and 9B). However, the method for forming the plural steps is not limited thereto.

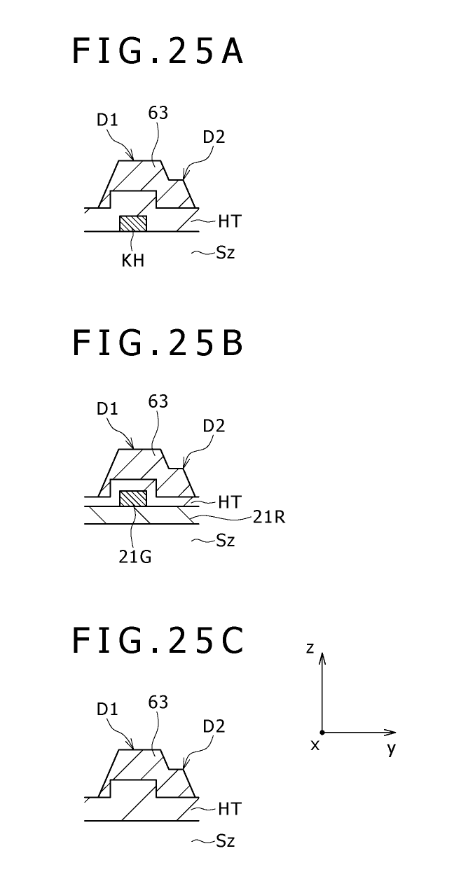

FIGS. 25A to 25C are sectional views showing elastic members in embodiments of the present invention.

As shown in FIG. 25A, the plural steps D1 and D2 may be formed in the elastic member 63 e.g. by forming a metal interconnect layer KH as the above-described underlying layer and providing a planarizing film HT on the metal interconnect layer KH.

In the case of providing the above-described elastic member 63 on the side of the counter substrate 202, the above-described underlying layer may be formed in the step of forming the color filter layer 21. In this case, as shown in FIG. 25B, a green filter 21G is stacked on a red filter 21R as the above-described underlying layer for example. Furthermore, the plural steps D1 and D2 may be provided by forming the elastic member 63 on the multilayer body of the red filter 21R and the green filter 21G.

As another method, as shown in FIG. 25C, the above-described underlying layer may be formed by pattern-processing the interlayer insulating film Sz.

By using another component also as the underlying layer in the above-described manner, the manufacturing cost can be reduced.

### (5) Others

In the above-described embodiments, the touch electrode 62t is formed monolithically with the pixel electrode 62p. However, embodiments of the present invention are not limited thereto. The touch electrode 62t and the pixel electrode 62p may be formed separately from each other. In this case, a circuit for controlling the detection operation of the touch sensor may be formed by providing a TFT (not shown) in addition to the pixel switching element 31 and driving this TFT independently of the operation of the pixel switching element.

In the above-described embodiments, the elastic member is provided on the TFT array substrate side. However, embodiments of the present invention are not limited thereto. The elastic member may be formed on the counter substrate side.

In the above-described embodiments, the touch electrode is formed on the liquid crystal alignment film on the counter substrate side. However, embodiments of the present invention are not limited thereto. The touch electrode may be formed under the liquid crystal alignment film. In this case, part of the liquid crystal alignment film may be removed so that the surface part of the touch electrode may be exposed.

In the above-described embodiments, the touch sensor of the one-point contact system, by which position detection is carried out through contact of a pair of touch electrodes opposed to each other, is employed. However, embodiments of the present invention are not limited thereto. For example, a touch sensor of the two-point contact system may be employed.

In the above-described embodiments, the touch electrode 25 and the common electrode 23 are formed independently of each other on the counter substrate side. However, embodiments of the present invention are not limited thereto. For example, the touch electrode 25 and the common electrode 23 may be formed monolithically with each other by using the same layer.

Embodiments of the present invention may be applied to, besides the above-described liquid crystal panels, liquid crystal panels of the lateral electric field systems such as the IPS system and the FFS system.

Embodiments of the present invention may be applied to display panels other than the liquid crystal panel, such as an organic EL display.

Embodiments of the present invention may be applied to, besides the built-in touch sensor included in the display panel, a touch sensor attached to the device as an external component.

In the above description, the embodiments of the present invention are applied to the touch sensor of the “contact type.” However, embodiments of the present invention are not limited thereto but may be applied to other systems such as the “resistive film type” and the “capacitive type.”

The liquid crystal display device 100 of the embodiments of the present invention can be used as a component in various kinds of electronic apparatus.

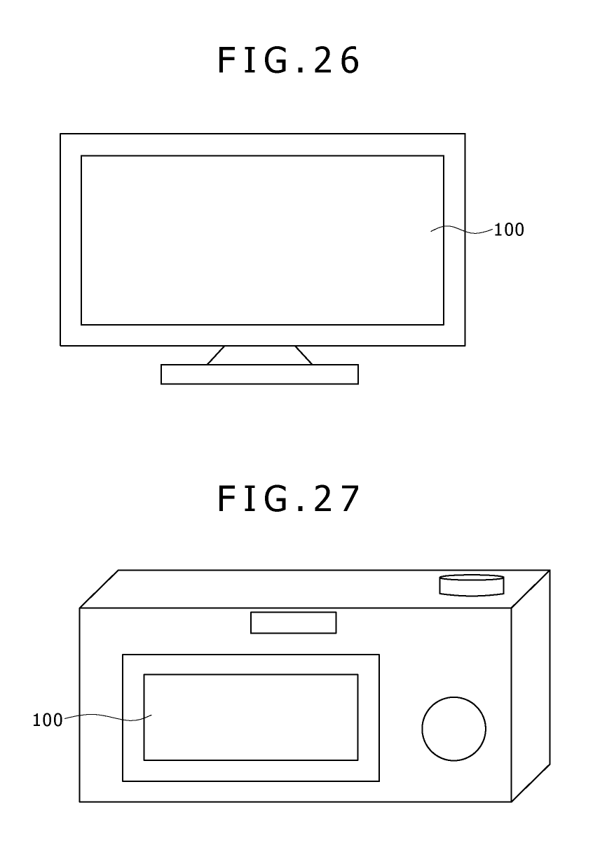

FIGS. 26 to 30 are diagrams showing electronic apparatuses to which the liquid crystal display device 100 according to the embodiment of the present invention is applied.

As shown in FIG. 26, in a television set that receives and displays television broadcasting, the liquid crystal display device 100 can be used as a display device that displays the received image on the display screen and accepts input of an operation command by the operator.

As shown in FIG. 27, in a digital still camera, the liquid crystal display device 100 can be used as a display device that displays images such as an image captured by imaging by the camera on the display screen and accepts input of an operation command by the operator.

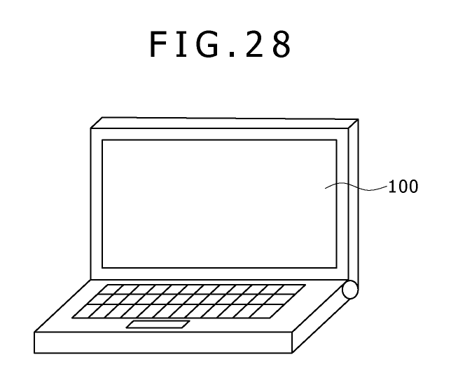

As shown in FIG. 28, in a notebook personal computer, the liquid crystal display device 100 can be used as a display device that displays an operation image and so forth on the display screen and accepts input of an operation command by the operator.

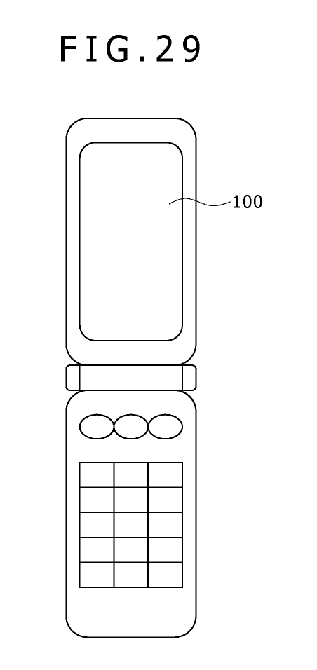

As shown in FIG. 29, in a cellular phone terminal, the liquid crystal display device 100 can be used as a display device that displays an operation image and so forth on the display screen and accepts input of an operation command by the operator.

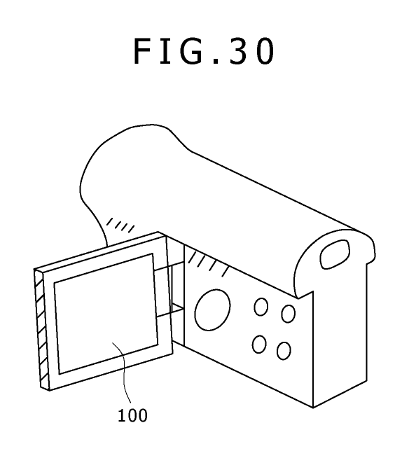

As shown in FIG. 30, in a video camcorder, the liquid crystal display device 100 can be used as a display device that displays an operation image and so forth on the display screen and accepts input of an operation command by the operator.

In the above-described embodiments, the touch electrode 25 is equivalent to the electrode and the second touch electrode set forth in the claims. In the above-described embodiments, the reflective electrode 62H is equivalent to the electrode set forth in the claims. In the above-described embodiments, the pixel electrodes 62p, 62pb, and 62pf are equivalent to the electrode and the pixel electrode set forth in the claims. In the above-described embodiments, the touch electrode 62t is equivalent to the electrode and the first touch electrode set forth in the claims. In the above-described embodiments, the elastic members 63, 63b, 63c, 63d, 63e, 63eb, 63f, and 63fb are equivalent to the elastic member set forth in the claims. In the above-described embodiments, the liquid crystal display device 100 is equivalent to the display device set forth in the claims. In the above-described embodiments, the liquid crystal panel 200 is equivalent to the display panel set forth in the claims. In the above-described embodiments, the TFT array substrate 201 is equivalent to the substrate set forth in the claims. In the above-described embodiments, the counter substrate 202 is equivalent to the counter substrate set forth in the claims. In the above-described embodiments, the liquid crystal layer 203 is equivalent to the liquid crystal layer set forth in the claims. In the above-described embodiments, the contact CT is equivalent to the contact set forth in the claims. In the above-described embodiments, the inclined surface KS is equivalent to the inclined surface set forth in the claims. In the above-described embodiments, the display area PA is equivalent to the display area set forth in the claims. In the above-described embodiments, the slits ST and STd are equivalent to the slit set forth in the claims. In the above-described embodiments, the touch sensor SWs is equivalent to the touch sensor set forth in the claims.

The present application contains subject matter related to that disclosed in Japanese Priority Patent Application JP 2009-023920 filed in the Japan Patent Office on Feb. 4, 2009, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. A display device comprising:
a display panel configured to display an image in a display area and have
a substrate over which a protruding elastic member and an electrode provided on the elastic member are formed in the display area; wherein
a plurality of steps are provided in the elastic member in a direction perpendicular to a surface of the substrate, and
the electrode is so provided on the elastic member as to include part covering a surface of the plurality of steps.

2. The display device according to claim 1, wherein
the plurality of steps are provided in the elastic member by a slit formed into a recess shape.

3. The display device according to claim 1, wherein
part of the plurality of steps of the elastic member includes an inclined surface inclined to the surface of the substrate, and the inclined surface is so formed that width of a section of the inclined surface along a plane perpendicular to the surface of the substrate becomes smaller as distance from the surface of the substrate becomes larger.

4. The display device according to claim 3, wherein
the inclined surface of the elastic member is so formed that width of the inclined surface becomes larger along a direction from an inner side toward an outer side in a plane parallel to the surface of the substrate.

5. The display device according to claim 1, wherein
the display panel includes a contact electrically connected to the electrode, and
the plurality of steps of the elastic member are so provided as to surround the contact in a plane parallel to the surface of the substrate.

6. The display device according to claim 1, wherein
the display panel includes a counter substrate opposed to the substrate with intermediary of a space and is provided with a touch sensor,
the touch sensor has
a first touch electrode provided over a surface of the substrate opposed to the counter substrate, and
a second touch electrode provided over a surface of the counter substrate opposed to the substrate in such a manner as to face the first touch electrode with intermediary of a space,
the touch sensor is so configured that the display panel is deformed due to external pressure and the first touch electrode and the second touch electrode get contact with each other, and
the first touch electrode is provided on a surface of the elastic member opposed to the counter substrate in such a manner as to include part covering the surface of the plurality of steps of the elastic member.

7. The display device according to claim 6, wherein
the display panel is a liquid crystal panel including a liquid crystal layer provided between the substrate and the counter substrate.

8. The display device according to claim 1, wherein
the electrode is provided as a pixel electrode for displaying an image in the display area.

9. The display device according to claim 1, wherein
a step located at a top surface, among the plurality of steps formed in the elastic member, is so formed as to be wider than the other steps.

10. A display device comprising
a display panel configured to include a touch sensor provided in a display area for displaying an image and have
a substrate, and
a counter substrate opposed to the substrate with intermediary of a space, wherein
the touch sensor has
a first touch electrode provided over a surface of the substrate opposed to the counter substrate, and
a second touch electrode provided over a surface of the counter substrate opposed to the substrate in such a manner as to face the first touch electrode with intermediary of a space,
the touch sensor is so configured that the display panel is deformed due to external pressure and the first touch electrode and the second touch electrode get contact with each other,
the substrate includes
an elastic member protruding in a direction toward the counter substrate over the surface of the substrate opposed to the counter substrate,
a plurality of steps are provided in the elastic member in the direction toward the counter substrate, and
the first touch electrode is provided on a surface of the elastic member opposed to the counter substrate in such a manner as to include part covering a surface of the plurality of steps of the elastic member.

11. A touch sensor comprising:
a substrate; and
a counter substrate configured to be so disposed as to be opposed to the substrate; wherein
the substrate includes
an elastic member protruding in a direction toward the counter substrate over a surface of the substrate opposed to the counter substrate, and
a first touch electrode provided on a surface of the elastic member opposed to the counter substrate,
the counter substrate includes
a second touch electrode provided over a surface of the counter substrate opposed to the substrate in such a manner as to face the first touch electrode with intermediary of a space,
at least one of the substrate and the counter substrate is deformed due to external pressure and the first touch electrode and the second touch electrode get contact with each other,
a plurality of steps are provided in the elastic member in the direction toward the counter substrate, and
the first touch electrode is so provided on the elastic member as to include part covering a surface of the plurality of steps of the elastic member.

12. A method for manufacturing a display device, the method comprising the step of:
manufacturing a display panel for displaying an image in a display area; wherein
the step of manufacturing the display panel includes the sub-steps of
forming a protruding elastic member over a substrate, and
forming an electrode on the elastic member,
in the sub-step of forming the elastic member, the elastic member is so formed that a plurality of steps are provided in a direction perpendicular to a surface of the substrate, and
in the sub-step of forming the electrode, the electrode is so provided on the elastic member as to cover a surface of the plurality of steps of the elastic member.

13. The method for manufacturing a display device according to claim 12, wherein
the sub-step of forming the elastic member includes the sub-steps of:
forming a photosensitive resin film covering an area in which the elastic member is to be formed; and
pattern-processing the photosensitive resin film by a photolithography technique to thereby form the elastic member.

14. The method for manufacturing a display device according to claim 12, wherein
the sub-step of forming the elastic member includes the sub-steps of:
forming a first photosensitive resin film covering an area in which the elastic member is to be formed;
pattern-processing the first photosensitive resin film by a photolithography technique to thereby form an underlying layer at part above which a step having a higher height among the plurality of steps to be formed in the elastic member is to be formed;
forming, on the underlying layer, a second photosensitive resin film covering the area in which the elastic member is to be formed; and
pattern-processing the second photosensitive resin film by a photolithography technique to thereby form the elastic member.

15. The method for manufacturing a display device according to claim 12, wherein
the sub-step of forming the elastic member includes the sub-steps of:
forming a first elastic member including a step having a lower height among the plurality of steps to be formed in the elastic member; and
forming a second elastic member including a step higher than the first elastic member among the plurality of steps to be formed in the elastic member;
the first elastic member and the second elastic member are provided as the elastic member,
the sub-step of forming the first elastic member includes the sub-steps of
forming a first photosensitive resin film covering an area in which the first elastic member is to be formed, and
pattern-processing the first photosensitive resin film by a photolithography technique to thereby form the first elastic member, and
the sub-step of forming the second elastic member includes the sub-steps of
forming, on the first elastic member, a second photosensitive resin film covering an area in which the second elastic member is to be formed, and
pattern-processing the second photosensitive resin film by a photolithography technique to thereby form the second elastic member.
